(19) United States
(12) Patent Application Publication
(10) Pub. No.: US 2024/0365282 A1
(43) Pub. Date: Oct. 31, 2024

(54) Managing Paging for a User Device

(71) Applicant: GOOGLE LLC, Mountain View, CA (US)

(72) Inventor: Chih-Hsiang Wu, Taoyuan City (TW)

(21) Appl. No.: 18/574,298

(22) PCT Filed: Jun. 22, 2022
(86) PCT No.: PCT/US22/34438

§ 371 Date: Dec. 26, 2023

Related U.S. Application Data
(60) Provisional application No. 63/214,880, filed on Jun. 25, 2021.

(51) Int. Cl. H04W 68/00

(52) U.S. Cl. CPC H04W 68/005

(57) ABSTRACT

A distributed unit, DU, of a distributed base station of a radio access network, RAN, the distributed base station including the DU and a central unit, CU, can implement a method for paging a user equipment, UE, when a radio connection between the distributed base station and the UE is not active. The method includes: receiving (1502), from the CU, a configuration for enhanced paging; and paging (1504) the UE using the configuration.

### FIELD OF THE DISCLOSURE

This disclosure relates generally to wireless communications and, more particularly, to paging a user equipment (UE) when the UE operates in an inactive or idle state associated with a protocol for controlling radio resources.

### BACKGROUND

This background description is provided for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

In telecommunication systems, the Packet Data Convergence Protocol (PDCP) sublayer of the radio protocol stack provides services such as transfer of user-plane data, ciphering, integrity protection, etc. For example, the PDCP layer defined for the Evolved Universal Terrestrial Radio Access (EUTRA) radio interface (see 3GPP specification TS 36.323) and New Radio (NR) (see 3GPP specification TS 38.323) provides sequencing of protocol data units (PDUs) in the uplink direction (from a user device, also known as a user equipment (UE), to a base station) as well as in the downlink direction (from the base station to the UE). Further, the PDCP sublayer provides services for signaling radio bearers (SRBs) to the Radio Resource Control (RRC) sublayer. The PDCP sublayer also provides services for data radio bearers (DRBs) to a Service Data Adaptation Protocol (SDAP) sublayer or a protocol layer such as an Internet Protocol (IP) layer, an Ethernet protocol layer, and an Internet Control Message Protocol (ICMP) layer. Generally speaking, the UE and a base station can use SRBs to exchange RRC messages as well as non-access stratum (NAS) messages, and can use DRBs to transport data on a user plane.

The RRC sublayer specifies the RRC_IDLE state, in which a UE does not have an active radio connection with a base station; the RRC_CONNECTED state, in which the UE has an active radio connection with the base station; and the RRC_INACTIVE state to allow a UE to more quickly transition back to the RRC_CONNECTED state due to Radio Access Network (RAN)-level base station coordination and RAN-paging procedures.

In some scenarios, a UE can operate in a state in which a radio resource control connection with the RAN is not active (e.g., RRC_IDLE or RRC_INACTIVE state) and subsequently transition to the connected state. Generally speaking, in the inactive state, the radio connection between the UE and the radio access network (RAN) is suspended. Later, when the UE is triggered to send data (e.g., outgoing phone call, browser launch) or receives a paging message from the base station, the UE can then transition to the connected state. To carry out the transition, the UE can request that the base station establish a radio connection (e.g., by sending an RRC Setup Request message to the base station) or resume the suspended radio connection (e.g., by sending an RRC Resume Request message to the base station), so that the base station can configure the UE to operate in the connected state.

In some cases, the UE in the RRC_IDLE or RRC_INACTIVE state has only one or some, relatively small packets to transmit or the base station has only one or some, relatively small packets to transmit to the UE operating in the RRC_IDLE or RRC_INACTIVE state. In these cases, the UE in the RRC_IDLE or RRC_INACTIVE state can perform an early data communication without transitioning to the RRC_CONNECTED state, e.g., by using techniques as specified in section 7.3a-7.3d in 3GPP specification 36.300 v16.4.0.

Recently, 3GPP has discussed various paging enhancements for UE power saving. For example, a base station can transmit a paging early indication (PEI) prior to a paging occasion. If a UE that supports detecting a PEI receives the PEI, the UE attempts to receive a paging downlink control information (DCI) at a subsequent paging occasion. If the UE does not receive the PEI, the UE can save power by not monitoring the subsequent paging occasion. As another example, a core network can configure a paging subgroup for a UE. A UE that supports paging subgroups can determine, based on whether a paging DCI indicates a paging subgroup of the UE, whether to receive a paging message in accordance with the paging DCI.

However, implementing paging enhancements for UE power saving presents several challenges. For example, with regard to paging subgrouping, while a core network can configure a UE with a paging subgroup, it is not clear how nodes of the radio access network (RAN) responsible for paging the UE obtain the paging subgroup configuration. If the RAN is not aware of the paging subgroup configuration, the RAN cannot transmit a paging subgroup indication to the UE, and the UE cannot take advantage of the paging subgroup paging enhancement to save power.

With regard to the PEI paging enhancement, because the RAN does not retain UE capabilities for a UE operating in an RRC_IDLE, the RAN is not aware of whether the UE operating in the RRC_IDLE state supports PEI. As a result, in some cases, the RAN will refrain from transmitting a PEI to the UE. If the RAN transmits a paging DCI to a UE that supports detecting a PEI, when the UE does not detect a PEI (due to the RAN not sending a PEI because the RAN is not aware that the UE supports PEI) then the UE will not attempt to receive a paging DCI. In other cases, the RAN may still transmit a PEI to the UE even though the RAN is not aware of whether the UE supports PEI. In such cases, the RAN may unnecessarily use radio resources to transmit a PEI to a UE that does not support PEI.

### SUMMARY

Network nodes of a radio access network (RAN) can use the techniques of this disclosure to manage paging. A central unit (CU) of a distributed base station can receive a configuration for enhanced paging from the core network (CN) or from another node of the RAN. The configuration indicates whether a UE supports enhanced paging functions, such as detecting a paging early indication (PEI) or utilizing paging subgrouping. If the CU determines to page the UE, the CU transmits the configuration to at least one distributed unit (DU) of the distributed base station to instruct the DU to page the UE using the configuration.

Based on the configuration, the DU determines how to page the UE. If the DU determines that the UE supports detecting a signal that notifies the UE to attempt to receive a paging downlink control information (DCI) (e.g., a PEI), then the DU pages the UE by transmitting the signal prior to transmitting the paging DCI. The DU then transmits a paging message to the UE in accordance with the DCI.

Further, if the DU determines, based on the configuration, that the UE supports paging subgrouping, then the DU can transmit an indication of the paging subgroup to the UE when paging the UE. For example, the DU can include an identifier of the paging subgroup (e.g., a paging subgroup identity (ID) or a subgroup-specific paging radio network temporary identifier (P-RNTI)) in the paging DCI, or can scramble a cyclic redundancy check (CRC) value for the paging DCI using the identifier. If the UE supports both detecting the signal and paging subgrouping, the DU can combine the techniques described above, or can transmit an indication of the paging subgroup within the signal.

One example embodiment of these techniques is a method implemented in a DU of a RAN, the distributed base station including the DU and a CU, for paging a UE when a radio connection between the distributed base station and the UE is not active. The method can be executed by processing hardware and includes: receiving, from the CU, a configuration for enhanced paging; and paging the UE using the configuration.

Another example embodiment of these techniques is a method implemented in a CU of a distributed base station of a RAN, the distributed base station including the CU and a DU, for paging a UE when a radio connection between the distributed base station and the UE is not active. The method can be executed by processing hardware and includes: receiving a configuration for enhanced paging; determining to page the UE; and in response to the determining, transmitting the configuration to the DU to instruct the DU to page the UE using the configuration.

Yet another example embodiment of these techniques is a method implemented in a base station for paging a UE, the base station operating one or more cells. The method can be implemented by processing hardware and includes: receiving a first list of frequency bands supported by the UE; generating a second list of frequency bands including frequency bands of the first list of frequency bands that are supported by the one or more cells; and paging the UE on cells of the one or more cells that support frequency bands of the second list of frequency bands.

A further example embodiment of these techniques is a method implemented in a CU of a distributed base station, the distributed base station including the CU and a DU, for paging a UE. The method can be implemented by processing hardware and includes: determining to page the UE; determining whether the UE is in an idle state associated with a protocol for controlling radio resources or an inactive state associated with the protocol; selecting a paging configuration based on whether the UE is in the idle state or the inactive state; and transmitting the paging configuration to the DU.

Another example embodiment of these techniques is a node of a RAN comprising processing hardware and configured to implement any one of the above methods.

### BRIEF DESCRIPTION OF THE DRAWINGS

FIG. 1A is a block diagram of an example wireless communication system in which a user device and a base station of this disclosure can implement the techniques of this disclosure for managing enhanced paging;

FIG. 1B is a block diagram of an example base station including a central unit (CU) and a distributed unit (DU) that can operate in the system of FIG. 1A;

FIG. 2A is a block diagram of an example protocol stack according to which the UE of FIG. 1A communicates with base stations;

FIG. 2B is a block diagram of an example protocol stack according to which the UE of FIG. 1A communicates with a CU and a DU;

FIG. 3A is an example message sequence in which a CU transmits a configuration for enhanced paging to a DU and the DU pages a UE using the configuration when the UE operates in an idle state;

FIG. 3B is an example message sequence in which a core network (CN) transmits a configuration for enhanced paging to both a first and a second base station;

FIG. 3C is an example message sequence similar to the message sequence of FIG. 3A, but where the CU also transmits the configuration for enhanced paging to a second DU;

FIG. 4A is an example message sequence similar to the message sequence of FIG. 3A, but where the DU pages the UE when the UE operates in an inactive state;

FIG. 4B is an example message sequence similar to the message sequence of FIG. 4A, but where the DU pages the UE to perform early data communication with the UE;

FIG. 4C is an example message sequence in which a CU transmits a configuration for enhanced paging to a DU and to a second base station, where the second base station pages the UE when the UE operates in the inactive state;

FIG. 4D is an example message sequence similar to the message sequence of FIG. 4A, but where the CU also transmits the configuration for enhanced paging to a second DU;

FIG. 5 is a flow diagram of an example method for determining whether to page a UE using enhanced or legacy paging, which can be implemented by a DU;

FIGS. 6A-6B are flow diagrams of example methods for distributing a configuration for enhanced paging, which can be implemented by a CU;

FIGS. 7A-7B are flow diagrams of example methods for transmitting a CU-to-DU message to a DU to instruct the DU to page a UE, which can be implemented by a CU and a CU control plane node (CU-CP), respectively;

FIGS. 8-11 are flow diagrams of example methods for determining a subset cells on which to page a UE, which can be implemented by a DU, a CU, a base station, and a CN, respectively;

FIGS. 12A-12B are flow diagrams of example methods for distributing UE paging capabilities, which can be implemented by a CU;

FIG. 13 is a flow diagram of an example method for determining a configuration to use for paging a UE, which can be implemented by a DU;

FIG. 14 is a flow diagram for selecting a paging configuration based on a radio resource control (RRC) state of a UE, which can be implemented by a CU;

FIG. 15 is a flow diagram of an example method for paging a UE, which can be implemented by a DU;

FIG. 16 is a flow diagram of an example method for paging a UE, which can be implemented by a CU;

FIG. 17 is a flow diagram of an example method for selecting cells on which to page a UE, which can be implemented by a CU or a DU; and

FIG. 18 is a flow diagram of an example method for selecting a paging configuration to use for paging a UE, which can be implemented by a CU.

### DETAILED DESCRIPTION OF THE DRAWINGS

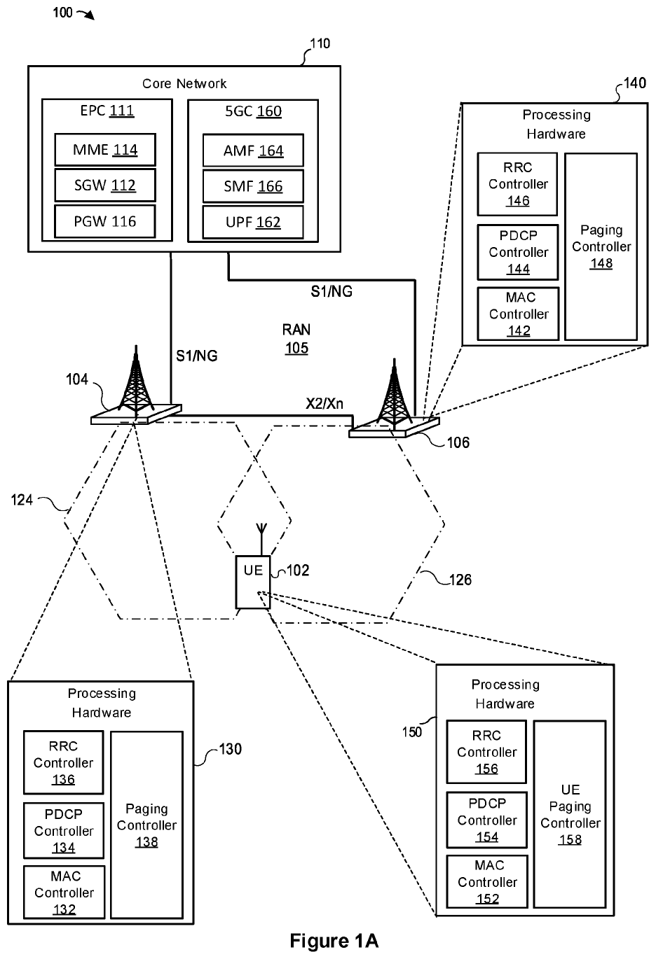

Referring first to FIG. 1A, an example wireless communication system 100 includes a UE 102, a base station (BS) 104, a base station 106, and a core network (CN) 110. The base stations 104 and 106 can operate in a radio access network (RAN) 105 connected to the core network (CN) 110. The CN 110 can be implemented as an evolved packet core (EPC) 111 or a fifth generation (5G) core (5GC) 160, for example. The CN 110 can also be implemented as a sixth generation (6G) core, in another example.

The base station 104 supports a cell 124, and the base station 106 supports a cell 126. The cells 124 and 126 can partially overlap, so that the UE 102 can select, reselect or hand over from one of the cells 124 or 126 to the other. If the base station 104 is a gNB, the cell 124 is a New Radio (NR) cell. If the base station 104 is an ng-eNB, the cell 124 is an evolved universal terrestrial radio access (E-UTRA) cell. Similarly, if the base station 106 is a gNB, the cell 126 is an NR cell, and if the base station 106 is an ng-eNB, the cell 126 is an E-UTRA cell. The cells 124 and 126 can be in the same Radio Access Network Notification Areas (RNA) or different RNAs. In general, the RAN 105 can include any number of base stations, and each of the base stations can cover one, two, three, or any other suitable number of cells. The UE 102 can support at least a 5G NR (or simply, “NR”) or E-UTRA air interface to communicate with the base stations 104 and 106. Each of the base stations 104, 106 can connect to the CN 110 via an interface (e.g., S1 or NG interface). The base stations 104 and 106 also can be interconnected via an interface (e.g., X2 or Xn interface) for interconnecting NG RAN nodes. The base station 104 and the base station 106 can directly exchange messages or information over the X2 or Xn interface. In general, the CN 110 can connect to any suitable number of base stations supporting NR cells and/or EUTRA cells.

Among other components, the EPC 111 can include a Serving Gateway (SGW) 112, a Mobility Management Entity (MME) 114, and a Packet Data Network Gateway (PGW) 116. The SGW 112 in general is configured to transfer user-plane packets related to audio calls, video calls, Internet traffic, etc., and the MME 114 is configured to manage authentication, registration, paging, and other related functions. The PGW 116 provides connectivity from the UE to one or more external packet data networks, e.g., an Internet network and/or an Internet Protocol (IP) Multimedia Subsystem (IMS) network. The 5GC 160 includes a User Plane Function (UPF) 162 and an Access and Mobility Management (AMF) 164, and/or Session Management Function (SMF) 166. Generally speaking, the UPF 162 is configured to transfer user-plane packets related to audio calls, video calls, Internet traffic, etc., the AMF 164 is configured to manage authentication, registration, paging, and other related functions, and the SMF 166 is configured to manage PDU sessions.

The CN 110 may determine to page the UE 102 if the CN receives downlink (DL) data for the UE 102 when a radio connection between the UE and the RAN 105 is not active (e.g., when the UE operates in an idle or an inactive state associated with a protocol for controlling radio resources, such as RRC_IDLE or RRC_INACTIVE).

In cases in which the UE operates in an idle state (e.g., RRC_IDLE or CM-IDLE), the CN 110 determines to page the UE 102 in order to send the DL data to the UE 102. In response to the determination, the CN 110 can perform paging operations with the RAN 105 to page the UE 102 operating in the idle state. More specifically, the CN 110 can send a CN-to-BS paging message (e.g., an NG application protocol (NGAP) Paging message as defined in 3GPP specification 38.413 or an S1 application protocol (S1AP) Paging message as defined in 3GPP specification 36.413) to the RAN 105 to trigger the RAN 105 to send a UE paging message to the UE 102. The CN 110 includes a CN ID of the UE 102 in the NGAP paging message. For example, the CN ID can be an S-TMSI or NG-5G-S-TMSI. In response to the CN-to-BS paging message, the base station 104 of the RAN 105 generates a UE paging message (e.g., RRC paging message defined in 3GPP specification 38.331) including the CN ID and sends the UE paging message via the cell 124 to page the UE 102. In cases that the base station 104 has additional cell(s), the base station 104 can also send the UE paging message via the addition cell(s) to page the UE 102. In response to or after receiving the UE paging message from the base station 104 e.g., via the cell 124, the UE 102 in the idle state can perform an RRC connection establishment procedure with the base station 104 to establish an RRC connection (i.e., SRB1 and/or SRB2) with the base station 104 and sends a Service Request message to the CN 110 via the base station 104 and the RRC connection (i.e., either the SRB1 or SRB2). After receiving the Service Request message, the CN 110 can send to the base station 104 a CN-to-BS message (e.g., PDU Session Resources Setup Request message or an Initial Context Setup Request message) to request the base station 104 to assign resources for the UE 102 to receive the DL data. The CN 110 can include a PDU Session ID and/or a Quality of Service (QOS) flow ID of the UE 102 in the CN-to-BS message to request the base station 104 to assign resources for a PDU Session and/or a QoS flow identified by the PDU Session ID and/or the QoS flow ID, respectively. In response to or after receiving the CN-to-BS message, the base station 104 activates security protection for the UE 102 and sets up a DRB for the PDU Session and/or QoS flow. The base station 104 can transmit to the UE 102 a security mode command message to activate the security protection, and the UE 102 can transmit a security mode complete message to the base station 104 in response. The base station 104 can transmit to the UE 102 an RRC reconfiguration message configuring the DRB for the PDU Session and/or QoS flow, and the UE 102 can transmit an RRC reconfiguration complete message to the base station 104 in response.

In cases in which the UE 102 operates in an inactive state (e.g., RRC_INACTIVE state), the CN 110 sends the DL data, e.g., via an NG-U connection or interface, to the RAN 105 without sending a CN-to-BS paging message (e.g., an NGAP Paging message as defined in 3GPP specification 38.413 or an S1AP Paging message as defined in 3GPP specification 36.413) for the UE 102 to the base station 104. After or in response to receiving the DL data, the base station 104 generates a UE paging message (e.g., RRC paging message defined in 3GPP specification 38.331) including an RAN ID of the UE 102 and sends the UE paging message via the cell 124 to page the UE 102. In cases that the base station 104 has additional cell(s), the base station 104 can also send the UE paging message via the addition cell(s) to page the UE 102. For example, the RAN ID can be an inactive radio network temporary identifier (I-RNTI) or a resume ID. In some scenarios and implementations, the base station 104 can send to the base station 106 a BS-to-BS paging message (e.g., a Xn Paging message as defined in 3GPP specification 38.423 or a X2 Paging message as defined in 3GPP specification 36.423) including the RAN ID to trigger the base station 106 to page the UE 102. In response to or in accordance with the BS-to-BS paging message, the base station 106 generates a UE paging message including the RAN ID and transmits the UE paging message via the cell 126. In cases that the base station 106 has additional cell(s), the base station 106 can also send the UE paging message via the additional cell(s) to page the UE 102. In response to or after receiving a UE paging from the base station 104, the UE 102 can perform an RRC connection resume procedure with the base station 104 to transition from the inactive state to a connected state (e.g., RRC_CONNECTED state). If the UE 102 is enabled by the RAN 105 for early data communication (or called small data transmission) and the UE paging message indicates that the UE 102 is to perform early data communication (e.g., mobile terminating early data transmission (EDT)), the UE 102 in the inactive state performs early data communication with the base station 104 without a state transition. During early data communication, the UE 102 can send an UL RRC message (e.g., RRC resume request message) including a message authentication code for integrity (MAC-I) to the base station 104 in response to the UE paging message. In the UL RRC message, the UE 102 can include an indication or cause value to indicate that the UE is performing early data communication in order to prevent the base station 104 from transitioning the UE 102 to the connected state. After receiving the UL RRC message, the base station 104 can send the DL data to the UE 102 operating in the inactive state.

The base station 104 is equipped with processing hardware 130 that can include one or more general-purpose processors (e.g., CPUs) and a non-transitory computer-readable memory storing instructions that the one or more general-purpose processors execute. Additionally or alternatively, the processing hardware 130 can include special-purpose processing units. The processing hardware 130 in an example implementation includes a Medium Access Control (MAC) controller 132 configured to perform a random access procedure with one or more user devices, receive uplink MAC protocol data units (PDUs) to one or more user devices, and transmit downlink MAC PDUs to one or more user devices. The processing hardware 130 can also include a Packet Data Convergence Protocol (PDCP) controller 134 configured to transmit PDCP PDUs in accordance with which the base station 104 can transmit data in the downlink direction, in some scenarios, and receive PDCP PDUs in accordance with which the base station 104 can receive data in the uplink direction, in other scenarios. The processing hardware further can include an RRC controller 136 to implement procedures and messaging at the RRC sublayer of the protocol communication stack. The processing hardware 130 in an example implementation includes a Paging controller 138 configured to manage paging operations with one or more UEs operating in the RRC_INACTIVE or RRC_IDLE state. The base station 106 can include processing hardware 140, which includes components generally similar to the components of the processing hardware 130. In particular, components 140, 142, 144, 146, and 148 can be similar to the components 130, 132, 134, 136, and 138, respectively.

The UE 102 is equipped with processing hardware 150 that can include one or more general-purpose processors such as CPUs and non-transitory computer-readable memory storing machine-readable instructions executable on the one or more general-purpose processors, and/or special-purpose processing units. The processing hardware 150 in an example implementation includes a Paging controller 158 configured to manage paging operations when the UE 102 operates in the RRC_IDLE or RRC_INACTIVE state. The processing hardware 150 in an example implementation includes a Medium Access Control (MAC) controller 132 configured to perform a random access procedure with a base station, transmit uplink MAC protocol data units (PDUs) to the base station, and receive downlink MAC PDUs from the base station. The processing hardware 150 can also include a PDCP controller 154 configured to transmit PDCP PDUs in accordance with which the UE 102 can transmit data in the uplink direction, in some scenarios, and receive PDCP PDUs in accordance with which the UE 102 can receive data in the downlink direction, in other scenarios. The processing hardware further can include an RRC controller 156 to implement procedures and messaging at the RRC sublayer of the protocol communication stack.

FIG. 1B depicts an example, distributed or disaggregated implementation of any one or more of the base stations 104, 106. In this implementation, the base station 104 or 106 includes a central unit (CU) 172 and one or more distributed units (DUs) 174. The CU 172 includes processing hardware, such as one or more general-purpose processors (e.g., CPUs) and a computer-readable memory storing machine-readable instructions executable on the general-purpose processor(s), and/or special-purpose processing units. For example, the CU 172 can include a PDCP controller, an RRC controller and/or a Paging controller such as PDCP controller 134, 144, RRC controller 136, 146 and/or Paging controller 138, 148. In some implementations, the CU 172 can include a radio link control (RLC) controller configured to manage or control one or more RLC operations or procedures. In other implementations, the CU 172 does not include a RLC controller.

Each of the DUs 174 also includes processing hardware that can include one or more general-purpose processors (e.g., CPUs) and computer-readable memory storing machine-readable instructions executable on the one or more general-purpose processors, and/or special-purpose processing units. For example, the processing hardware can include a MAC controller (e.g., MAC controller 132, 142) configured to manage or control one or more MAC operations or procedures (e.g., a random access procedure), and/or a RLC controller configured to manage or control one or more RLC operations or procedures. The processing hardware can also include a physical layer controller configured to manage or control one or more physical layer operations or procedures.

In some implementations, the CU 172 can include a logical node CU-CP 172A that hosts the control plane part of the PDCP protocol of the CU 172. The CU 172 can also include logical node(s) CU-UP 172B that hosts the user plane part of the PDCP protocol and/or Service Data Adaptation Protocol (SDAP) protocol of the CU 172. The CU-CP 172A can transmit control information (e.g., RRC messages, F1 application protocol messages), and the CU-UP 172B can transmit the data packets (e.g., SDAP PDUs or Internet Protocol packets).

The CU-CP 172A can be connected to multiple CU-UP 172B through the E1 interface. The CU-CP 172A selects the appropriate CU-UP 172B for the requested services for the UE 102. In some implementations, a single CU-UP 172B can be connected to multiple CU-CP 172A through the E1 interface. If the CU-CP and DU(s) belong to a gNB, the CU-CP 172A can be connected to one or more DU 174s through an F1-C interface and/or an F1-U interface. If the CU-CP and DU(s) belong to an ng-eNB, the CU-CP 172A can be connected to one or more DU 174s through a W1-C interface and/or a W1-U interface. In some implementations, one DU 174 can be connected to multiple CU-UPs 172B under the control of the same CU-CP 172A. In such implementations, the connectivity between a CU-UP 172B and a DU 174 is established by the CU-CP 172A using Bearer Context Management functions.

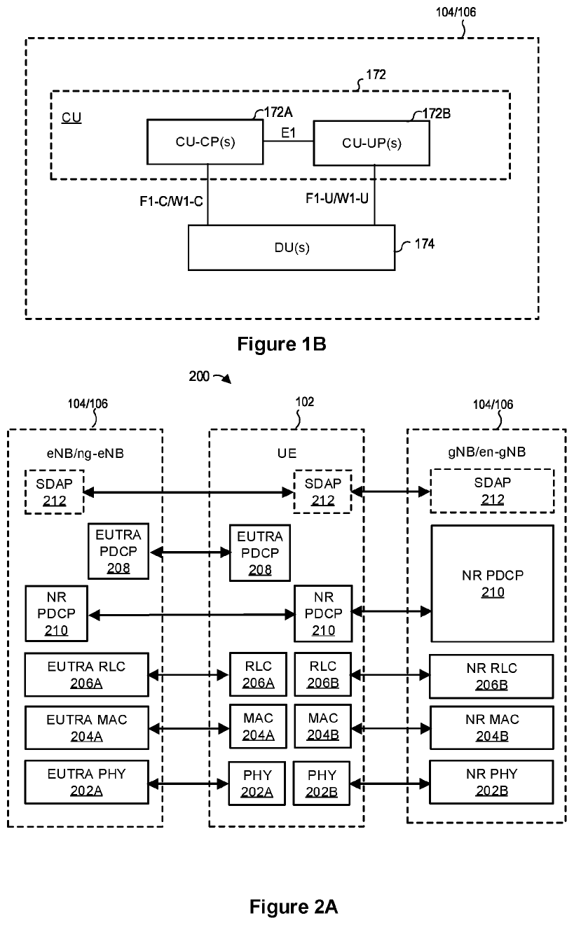

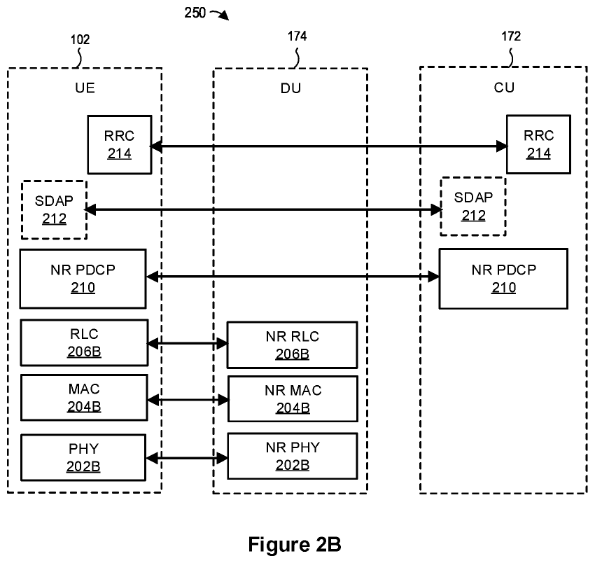

FIG. 2A illustrates, in a simplified manner, an example protocol stack 200 according to which the UE 102 can communicate with an eNB/ng-eNB or a gNB (e.g., one or more of the base stations 104, 106).

In the example stack 200, a physical layer (PHY) 202A of EUTRA provides transport channels to the EUTRA MAC sublayer 204A, which in turn provides logical channels to the EUTRA RLC sublayer 206A. The EUTRA RLC sublayer 206A in turn provides RLC channels to a EUTRA PDCP sublayer 208 and, in some cases, to an NR PDCP sublayer 210. Similarly, the NR PHY 202B provides transport channels to the NR MAC sublayer 204B, which in turn provides logical channels to the NR RLC sublayer 206B. The NR RLC sublayer 206B in turn provides data transfer services to the NR PDCP sublayer 210. The NR PDCP sublayer 210 in turn can provide data transfer services to Service Data Adaptation Protocol (SDAP) 212 or a radio resource control (RRC) sublayer (not shown in FIG. 2A). The UE 102, in some implementations, supports both the EUTRA and the NR stack as shown in FIG. 2A, to support handover between EUTRA and NR base stations and/or to support DC over EUTRA and NR interfaces. Further, as illustrated in FIG. 2A, the UE 102 can support layering of NR PDCP 210 over EUTRA RLC 206A, and SDAP sublayer 212 over the NR PDCP sublayer 210.

The EUTRA PDCP sublayer 208 and the NR PDCP sublayer 210 receive packets (e.g., from an Internet Protocol (IP) layer, layered directly or indirectly over the PDCP layer 208 or 210) that can be referred to as service data units (SDUs), and output packets (e.g., to the RLC layer 206A or 206B) that can be referred to as protocol data units (PDUs). Except where the difference between SDUs and PDUs is relevant, this disclosure for simplicity refers to both SDUs and PDUs as “packets.”

On a control plane, the EUTRA PDCP sublayer 208 and the NR PDCP sublayer 210 can provide signaling radio bearers (SRBs) or RRC sublayer (not shown in FIG. 2A) to exchange RRC messages or non-access-stratum (NAS) messages, for example. On a user plane, the EUTRA PDCP sublayer 208 and the NR PDCP sublayer 210 can provide data radio bearers (DRBs) to support data exchange. Data exchanged on the NR PDCP sublayer 210 can be SDAP PDUs, Internet Protocol (IP) packets or Ethernet packets.

Thus, it is possible to functionally split the radio protocol stack, as shown by the radio protocol stack 250 in FIG. 2B. The CU 172 at any of the base stations 104 or 106 can hold all the control and upper layer functionalities (e.g., RRC 214, SDAP 212, NR PDCP 210), while the lower layer operations (e.g., NR RLC 206B, NR MAC 204B, and NR PHY 202B) are delegated to the DU 174. To support connection to a 5GC, NR PDCP 210 provides SRBs to RRC 214, and NR PDCP 210 provides DRBs to SDAP 212 and SRBs to RRC 214.

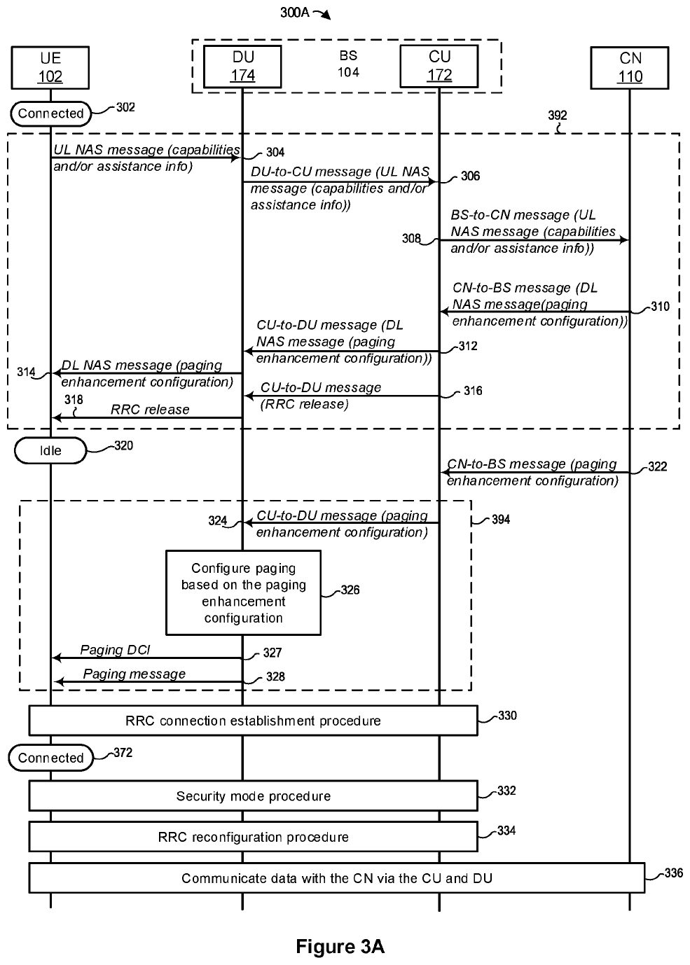

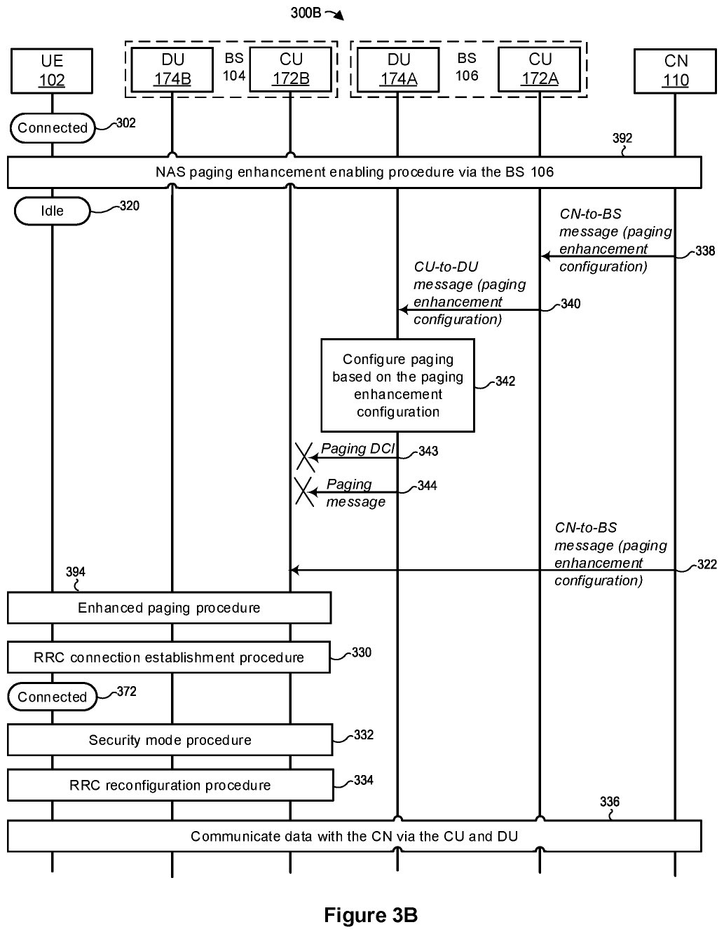

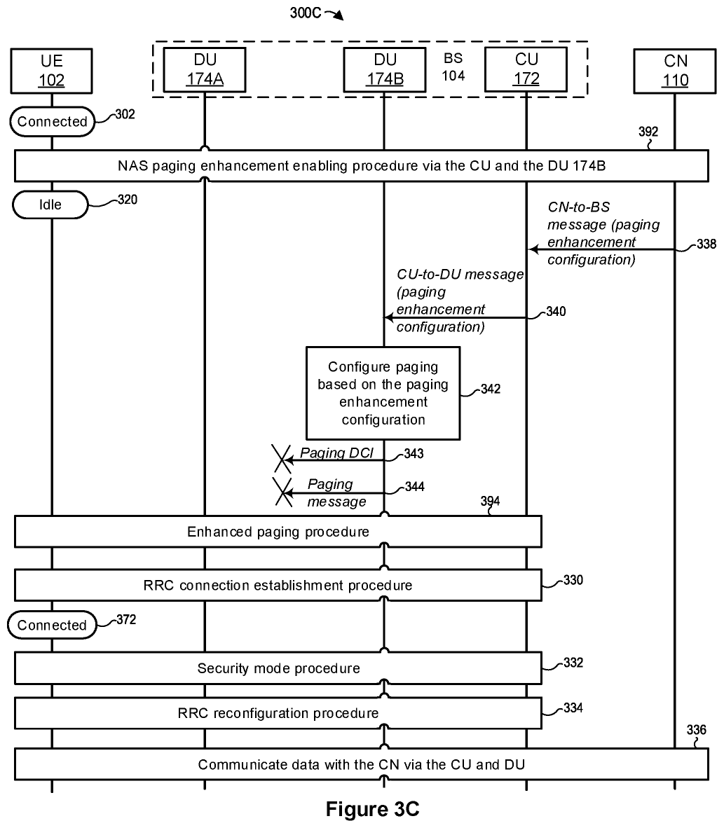

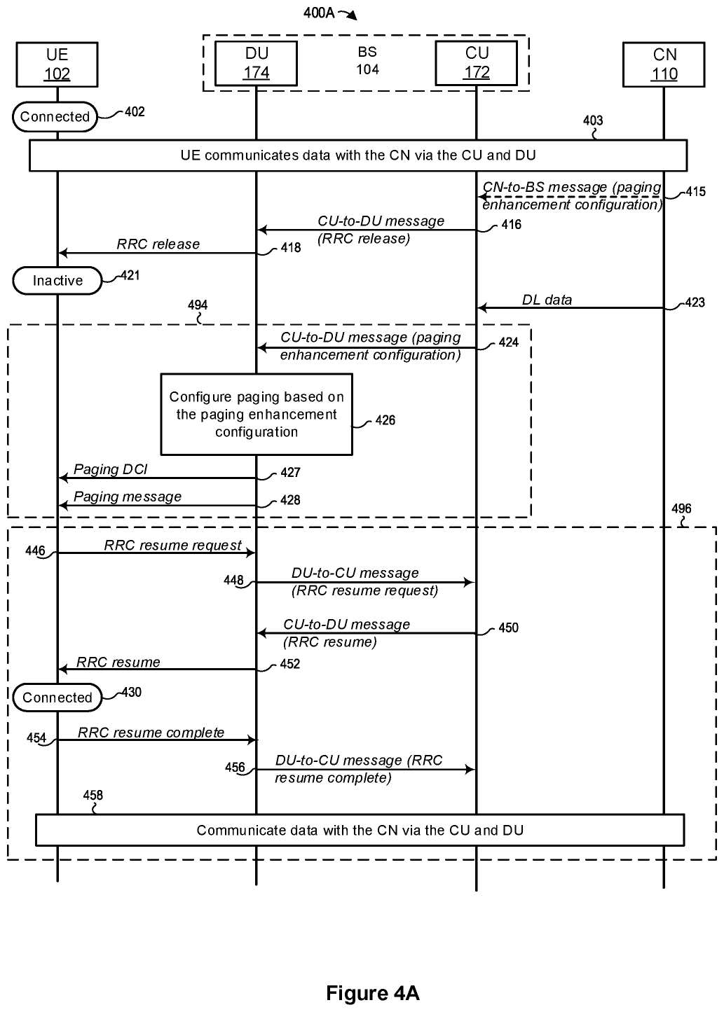

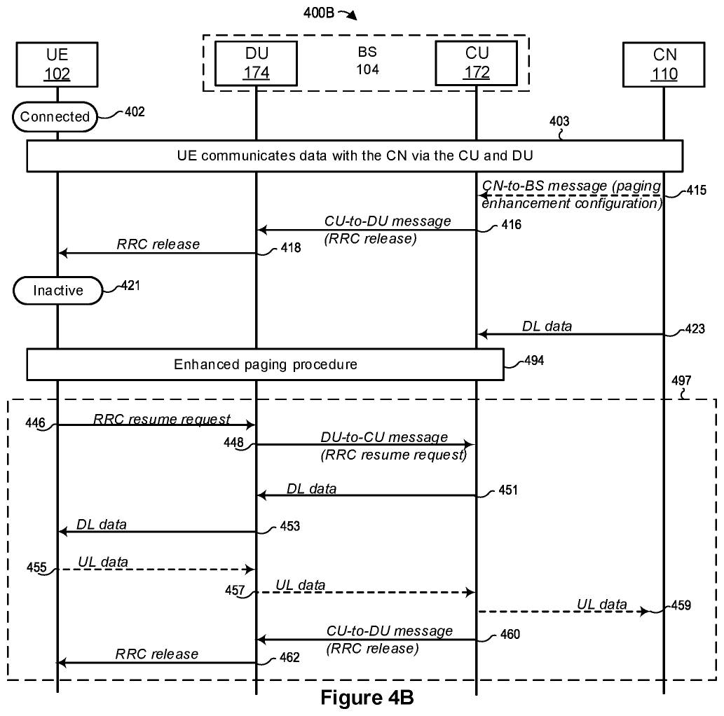

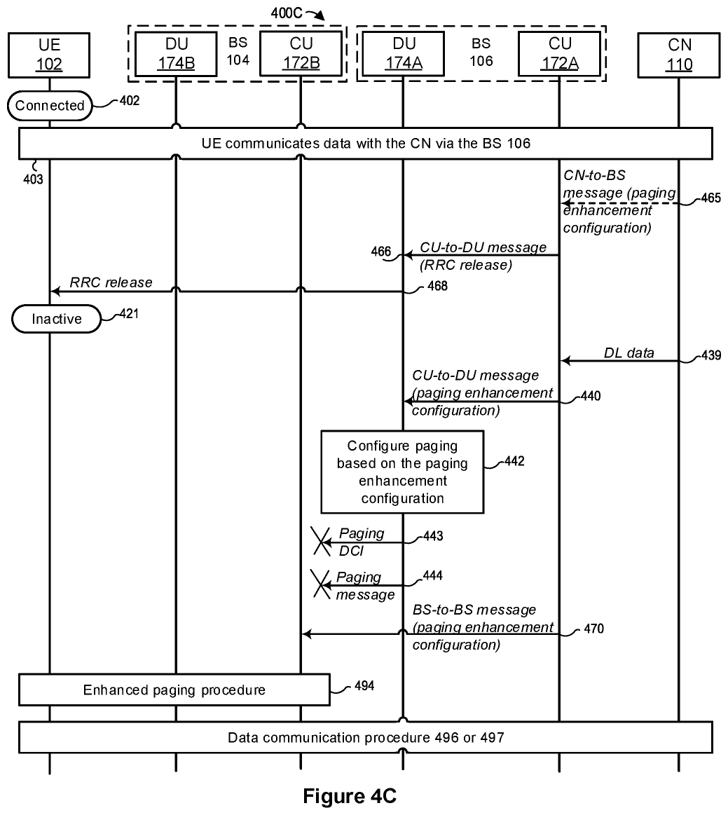

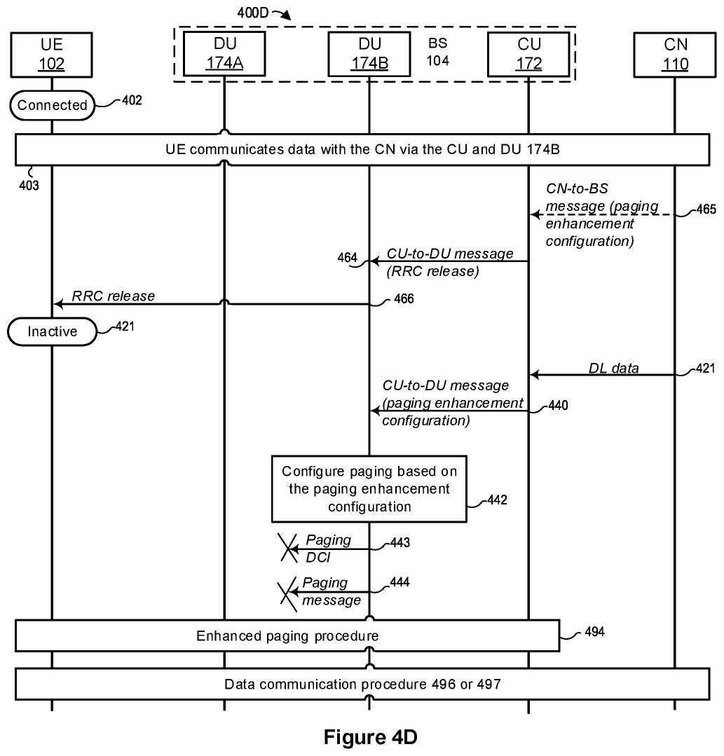

FIGS. 3A-4D are message sequences of example scenarios in which a CU transmits a paging enhancement configuration to a DU to enable the DU to page a UE using the paging enhancement configuration. Generally speaking, events in FIGS. 3A-3C and 4A-4D that are similar are labeled with similar reference numbers (e.g., event 394 in FIG. 3A is similar to event 394 in FIGS. 3B-3C and event 494 in FIGS. 4A-4D), with differences discussed below where appropriate. With the exception of the differences shown in the figures and discussed below, any of the alternative implementations discussed with respect to a particular event (e.g., for messaging and processing) may apply to events labeled with similar reference numbers in other figures.

Referring first to FIG. 3A, in a scenario 300A, the UE 102 initially operates 302 in a connected state (e.g., RRC_CONNECTED) with the base station 104 including a CU 172 and a DU 174. While the UE 102 operates in the connected state, the UE 102 transmits 304 an uplink (UL) NAS message including capabilities and/or assistance information to the DU 174. In turn, the DU 174 sends 306 a DU-to-CU message including the UL NAS message to the CU 172. Then the CU 172 sends 308 a BS-to-CN message including the UL NAS message to a CN 110 (e.g., AMF 164 or MME 114). In some implementations, the UE 102 can indicate support of paging enhancement configuration(s) in the capabilities and/or assistance information. After the CN 110 receives the capabilities and/or assistance information in the UL NAS message, the CN 110 can determine to generate a paging enhancement configuration in response to or in accordance with the support indication(s) of paging enhancement configuration(s) in the capabilities and/or assistance information. If the UE 102 does not indicate any support for paging enhancement, then the CN 110 does not create a paging enhancement configuration for the UE 102. The paging enhancement configuration, also referred to in this disclosure as a configuration for enhanced paging, enables the UE 102 to use a corresponding paging enhancement function to manage paging reception. In response to the determination, CN 110 generates a DL NAS message including the paging enhancement configuration and sends 310 a first CN-to-BS message including the DL NAS message to the CU 172. In turn, the CU 172 sends 312 a first CU-to-DU message including the DL NAS message to the DU 174. The DU 174 then transmits 314 the DL NAS message to the UE 102.

In some implementations as shown, the CN 110 can generate, determine, or select the paging enhancement configuration in accordance with or in response to the capabilities and/or assistance information. In other implementations not shown, the CN 110 can obtain the paging enhancement configuration from the CU 172. For example, after receiving the capabilities and/or assistance information, the CN 110 can send an additional CN-to-BS message to the CU 172 to request the CU 172 to provide the paging enhancement configuration, and in response, the CU 172 sends an additional BS-to-CN message including the paging enhancement configuration to the CN 110.

After a certain period of data inactivity for the UE 102, the CU 172 can determine that neither the CU 172 nor the UE 102 has transmitted any data in the downlink direction or the uplink direction, respectively, during the certain period. In some implementations, the DU 174 can send (not shown) a DU-to-CU message indicating data inactivity of the UE 102 to the CU 172 to assist the determination. In response to the determination, the CU 172 sends 316 a second CU-to-DU message including an RRC release message to the DU 174, which in turn transmits 318 the RRC release message to the UE 102. The UE 102 transitions 320 to an idle state (e.g., RRC_IDLE state) in response to receiving the RRC release message and operates in the idle state.

In some implementations, the UL NAS message and the DL NAS message can be 5G mobility management (MM) messages or 5G session management (SM) messages (e.g., as described in 3GPP specification 24.501). For example, the UL NAS message can be a Registration Request message or a Registration Complete message. In another example, the DL NAS message can be a Registration Accept message or a Configuration Update Command message. In some implementations, the DU-to-CU message, the first CU-to-DU message and the second CU-to-DU message are F1 application protocol (F1AP) or W1 application protocol (W1AP) messages (e.g., as described in 3GPP specifications 38.473 or 37.473). For example, the DU-to-CU message, the first CU-to-DU message and the second CU-to-DU message can be a UL RRC Message Transfer message, a DL RRC Message Transfer message, and a UE Context Release Command message, respectively. In some implementations, the BS-to-CN message and the first CN-to-BS message are NG application protocol (NGAP) messages. For example, the BS-to-CN message is an Initial UE Message message or an Uplink NAS Transport message. In another example, the first CN-to-BS message is an Initial Context Setup Request message or a Downlink NAS Transport message.

The events 304, 306, 308, 310, 312, 314, 316, 318 and 320 are collectively referred to in FIG. 3A as a NAS paging enhancement enabling procedure 392.

At a later time, the CN 110 determines to page the UE 102, e.g., for a mobile terminating call or to transmit DL data to the UE 102. In response to the determination, the CN 110 sends 322 to the CU 172 a second CN-to-BS message including the paging enhancement configuration. In the second CN-to-BS message, the CN 110 in some implementations can include a NAS ID of the UE 102, one or more capabilities of the UE 102 for paging, and/or paging assistance information for the UE 102. In some implementations, the NAS ID can be an S-TMSI or a 5G-S-TMSI. In one implementation, the CN 110 includes the NAS ID in the DL NAS message 310. In another implementation, the CN 110 sends a second DL NAS message including the NAS ID to the UE 102 via the CU 172 and DU 174, similar to events 310, 312 and 314, before sending the second CN-to-BS message.

In some implementations, the one or more capabilities for paging are included in a UE paging capability IE (e.g., a UERadioPagingInformation IE), and the CN 110 includes the UE paging capability IE in the second CN-to-BS message. In some implementations, the one or more capabilities is included in a UE full capability IE (e.g., UE-NR-Capability IE) of the UE 102. The UE full capability IE includes other capabilities in addition to the one or more capabilities in the UE paging capability IE. In some implementations, the CN 110 can receive the UE paging capability IE and/or the UE full capability IE from the RAN 105 (e.g., the CU 172 or another CU or base station). In other implementations, the CN 110 can pre-store the UE full capability IE. In such implementations, the CN 110 can either pre-store the UE paging capability IE or dynamically generate the UE paging capability IE from the UE full capability IE. In some implementations, the CN 110 can associate a capability ID with the UE full capability IE and/or the UE paging capability.

In some implementations, the one or more capabilities include a frequency band list for paging (e.g., supportedBandListNRForPaging field) including frequency band(s) supported by the UE 102. In some implementations, the UE full capability IE includes a full frequency band list (e.g., supportedBandListNR field) including full frequency bands supported by the UE 102. The RAN 105 or the CN 110 can generate the frequency band list for paging from the full frequency band list. In some implementations, the RAN 105 or the CN 110 can include a subset of the full frequency bands in the frequency band list for paging. For example, the RAN 105 or the CN 110 can select frequency band(s) supported by the RAN 105 from the full frequency bands. In other implementations, the RAN 105 or the CN 110 can include the full frequency bands in the frequency band list for paging.

In other implementations, the one or more capabilities include one or more downlink scheduling slot offset capabilities (e.g., dl-SchedulingOffset-PDSCH-TypeA-FDD-FRI-r15, dl-SchedulingOffset-PDSCH-TypeA-TDD-FRI-r15, dl-SchedulingOffset-PDSCH-TypeB-FDD-FRI-r15, and/or dl-SchedulingOffset-PDSCH-TypeB-FDD-FRI-r15) to indicate that the UE 102 supports cross-slot scheduling. In yet other implementations, the one or more capabilities include a single capability field/IE to indicate support of a PEI signal while the UE 102 operates in the idle state (e.g., RRC_IDLE) and/or an inactive state (e.g., RRC_INACTIVE). Alternatively, the one or more capabilities include a first capability field/IE and a second capability field/IE to indicate support of a PEI signal while the UE 102 operates in the idle state and support of a PEI signal while the UE 102 operates in the inactive state, respectively.

In some implementations, the paging assistance information includes a paging discontinuous reception (DRX) configuration, paging priority, paging origin, and/or a tracking area identity (TAI) list for paging. The paging DRX information can include a paging DRX cycle value. In some implementations, the paging DRX cycle value can be 32, 64, 128 or 256 radio frames. In other implementations, the paging DRX cycle value can be 512 or 1024 radio frames. The paging DRX configuration can be paging discontinuous reception (DRX) information (e.g., Paging DRX IE) or paging extended DRX (eDRX) information (e.g., Paging eDRX Information IE). The paging eDRX information can include a paging eDRX cycle value (e.g., 0.5, 1, 2, 4, 6, 8, 10, 12, 14, 16, 32, 64, 128, 256 hyper frame(s)) and/or a paging time window value.

In some implementations, the second CN-to-BS message can be an NGAP Paging message described in 3GPP specification 38.413. In some implementations, the CN 110 includes the paging DRX information or the paging eDRX information in the DL NAS message 310 or the second DL NAS message.

In response to or after receiving the second CN-to-BS message, the CU 172 retrieves the paging enhancement configuration from the second CN-to-BS message and sends 324 to the DU 174 a third CU-to-DU message including the paging enhancement configuration. In some implementations, the CU 172 can retrieve the NAS ID from the second CN-to-BS message and include the NAS ID in the third CU-to-DU message. In some implementations, the CU 172 can retrieve the paging origin from the second CN-to-BS message and include the paging origin in the third CU-to-DU message.

In some implementations, the CU 172 can directly include the retrieved paging enhancement configuration in the third CU-to-DU message without decoding the retrieved paging enhancement configuration to a certain type of data and then encoding the data to the paging enhancement configuration as an IE of the third CU-to-DU message. An advantage of such implementations is that the CU 172 does not need to process or comprehend the paging enhancement configuration, i.e., the CU 172 is transparent to the paging enhancement configuration. In some implementations, the paging enhancement configuration can be an RRC information element (IE). In some implementations, the third CU-to-DU message can be a F1AP Paging message described in 3GPP specification 38.473. In other implementations, the third CU-to-DU message can be a W1AP Paging message described in 37.473.

In other implementations, the CU 172 decodes the retrieved paging enhancement configuration (i.e., an IE of the second CN-to-BS message) to a certain type of data and then encodes the data to the paging enhancement configuration as an IE of the third CU-to-DU message. An advantage of such implementations is that the CU 172 can determine whether to augment or adjust configuration parameters of the retrieved paging enhancement configuration based on condition(s) or implementations of the DU 174 and/or the CU 172. For example, because the DU 174 may not support a particular configuration parameter in the retrieved paging enhancement configuration, the CU 172 can determine to exclude the particular configuration parameter from the paging enhancement configuration of the third CU-to-DU message. In another example, because the DU 174 may not support a particular value of a configuration parameter in the retrieved paging enhancement configuration, the CU 172 can change the particular value to another value supported by the DU 174. In some implementations, the retrieved paging enhancement configuration is an NGAP IE and the paging enhancement configuration of the third CU-to-DU message is an F1AP IE or a W1AP IE.

In some implementations, if the second CN-to-BS message includes the one or more capabilities for paging, the CU 172 can include the one or more capabilities for paging in the third CU-to-DU paging message. For example, the second CN-to-BS message can include the UE paging capability IE and the CU 172 can include the UE paging capability IE in the third CU-to-DU message. In other implementations, the second CN-to-BS message can include the paging assistance information for the UE 102 in an IE of the second CN-to-BS message. For example, if the second CN-to-BS message is an NGAP message, the IE can be an NGAP IE. In such implementations, the CU 172 retrieves the paging assistance information from the IE of the second CN-to-BS message and includes (a portion of) the paging assistance information in an IE of the third CU-to-DU message. In some implementations, the CU 172 can modify (a portion of) the paging assistance information and include the modified (portion of) paging assistance information in the third CU-to-DU message. In some scenarios and implementations, the paging assistance information in the second CN-to-BS message includes paging DRX information including a paging DRX cycle value: 512 or 1024 radio frames. The CU 172 can set the paging DRX cycle value in the third CU-to-DU message to 32, 64, 128 or 256 radio frames instead of 512 or 1024 radio frames when one of the CU 172 and DU 174 does not support 512 or 1024 radio frames. In some implementations, the CU 172 or DU 174 does not support 512 or 1024 radio frames because the paging assistance information IE of the third CU-to-DU message does not support a paging DRX cycle value with either 512 or 1024 radio frames. In other implementations, an extended paging DRX cycle value (i.e., 512 and 1024 radio frames) can be included in a new format of the paging assistance information IE of the third CU-to-DU message. If the CU 172 and DU 174 support the new format (i.e., support paging DRX cycle with 512 or 1024 radio frames), the CU 172 can set the paging DRX cycle to 512 or 1024 radio frames in the third CU-to-DU message. If the CU 172 supports the new format but the DU 174 does not support the new format, the CU 172 can set the paging DRX cycle value in the third CU-to-DU message to 32, 64, 128 or 256 radio frames instead of 512 or 1024 radio frames.

In response to or after receiving the third CU-to-DU message, the DU 174 generates a Paging message (e.g., an RRC Paging message defined in 3GPP specification 38.331) for paging the UE 102 and configures 326 paging the UE 102, in accordance with, or taking into account, the paging enhancement configuration, the one or more capabilities for paging, and the paging assistance information in the third CU-to-DU message. Configuring paging the UE 102 includes determining how to page the UE 102 in view of the paging enhancement configuration (e.g., determining whether to transmit a PEI prior to transmitting a paging DCI scheduling a Paging message, determining whether to transmit an indication of a paging subgroup to the UE 102 when paging the UE 102, generating a paging DCI, etc.).

To configure paging the UE 102, the DU 174 generates a paging DCI that schedules and allocates radio resources for transmission of the Paging message on cell(s) (e.g., cell 124) of the DU 174. If the CU 172 includes a paging cell list in the third CU-to-DU message 324, the DU 174 schedules and allocates radio resources for transmission of the Paging message on cell(s) in the paging cell list. The DU 174 transmits 327 the paging DCI and 328 the Paging message over the cell(s) to page the UE 102 in accordance with the determination at event 326. In some implementations, the DU 174 at event 326 can configure transmission of the paging DCI on a paging occasion, e.g., in accordance with 3GPP specification 38.304. In some implementations, the DU 174 determines the paging occasion in an on-duration of a paging DRX cycle in accordance with the paging DRX information or the paging eDRX information. The UE 102 attempts to receive the paging DCI on a paging occasion, e.g., in accordance with 3GPP specification 38.304. In some implementations, the UE 102 determines the paging occasion in an on-duration of a paging (c) DRX cycle in accordance with the paging DRX information or the paging eDRX information. In some implementations, the DU 174 at event 326 can determine to transmit the Paging message on the same or different radio resources multiple times. In such implementations, the DU 174 transmits a paging DCI for each transmission of the Paging message. The paging DCI for each transmission can be the same or different.

In some implementations, the UE 102 can indicate support of paging subgrouping in the UE capabilities and/or assistance information. As one example, the UE 102 can indicate support of the paging subgrouping using a subgroup-specific paging radio network temporary identifier (P-RNTI) in the UE capabilities and/or assistance information. If the UE 102 supports paging subgrouping, the paging enhancement configuration at events 314, 324 includes an indication of the paging subgroup assigned to the UE 102 by the CN 110. For example, the paging enhancement configuration may include a paging subgroup configuration that configures the UE 102 a paging subgroup (e.g., the paging enhancement configuration may include a paging subgroup identity (ID), or may include or indicate the subgroup-specific P-RNTI).

If the paging enhancement configuration indicates that the UE 102 supports paging subgrouping, the DU 174 can determine at event 326 to transmit an indication of the paging subgroup to the UE 102 when paging the UE 102. For example, the DU 174 can indicate the paging subgroup in the paging DCI. In some implementations, the DU 174 includes the paging subgroup ID in the paging DCI. In other implementations, the DU 174 sets a field to a value corresponding to the paging subgroup. If the paging DCI indicates the paging subgroup, the UE 102 attempts to receive a Paging message in accordance with the paging DCI. If the paging DCI does not indicate the paging subgroup, the UE 102 discards or ignores the paging DCI, or refrains from attempting to receive a Paging message in accordance with the paging DCI.

In other implementations, the DU 174 can indicate the paging subgroup by scrambling a CRC of the paging DCI with the subgroup-specific P-RNTI and transmit the paging DCI and the scrambled CRC on a PDCCH, e.g., at event 327. If the UE 102 receives the paging DCI and the scrambled CRC on the PDCCH and identifies the paging DCI as intended for the UE 102 based on the scrambled CRC and the subgroup-specific P-RNTI, the UE 102 attempts to receive the Paging message. If the UE 102 receives a paging DCI and a scrambled CRC on a PDCCH and identifies the paging DCI as not intended for the UE 102 based on the scrambled CRC and the subgroup-specific P-RNTI, the UE 102 discards or ignores the paging DCI or refrains from receiving a Paging message in accordance with the paging DCI. The UE 102 can obtain or derive the subgroup-specific P-RNTI from the paging enhancement configuration.

In some implementations the UE 102 can indicate whether the UE 102 supports detecting a paging early indication (PEI) signal in the UE capabilities and/or assistance information. If the UE 102 supports detecting the PEI signal, the paging enhancement configuration(s) includes a PEI configuration that configures the UE 102 to receive or detect a PEI signal before receiving a paging DCI and/or a Paging message. If the UE 102 receives or detects a PEI signal, the UE 102 attempts to receive the paging DCI. In some implementations, the PEI signal can be a wake-up signal (WUS) for paging. Thus, if the UE 102 supports detecting the PEI, the DU 174 determines at event 326 to transmit a PEI signal prior to transmitting 327 the paging DCI.

In some implementations, the paging enhancement configuration indicates that the UE 102 supports both paging subgrouping and detecting a PEI signal. For example, the UE 102 may indicate that the UE 102 supports paging subgrouping and detecting a PEI signal in the UE capabilities and/or assistance information. Additionally or alternatively, the UE 102 can specifically indicate support for identifying a paging subgrouping using a PEI signal in the UE capabilities and/or assistance information. If the UE 102 supports both paging subgrouping and detecting a PEI signal, the DU 174 can determine at event 326 to indicate the paging subgroup in the PEI signal. For example, the DU 174 can generate the PEI signal including a specific sequence to indicate the paging subgroup. If the UE 102 receives or detects the PEI signal, the UE 102 attempts to receive the paging DCI. If the UE 102 receives or detects a PEI signal including another sequence or does not receive or detect the PEI signal including the specific sequence for the paging subgroup, the UE 102 does not attempt to receive the paging DCI on the paging occasion of the UE 102.

In cases that the CU 172 operates other DU(s) in addition to the DU 174, the CU 172 can send to each of the other DU(s) a CU-to-DU message similar to the third CU-to-DU message. See FIG. 3C. Similarly, the CU 172 can include a particular paging cell list in each of the CU-to-DU paging message(s). In response to the CU-to-DU message, a particular DU generates a paging DCI and a Paging message (e.g., an RRC Paging message defined in 3GPP specification 38.331) for paging the UE 102 and configures transmission of the paging DCI and the Paging message similar to event 326. In some implementations, the CU 172 can retrieve a TAI list or RNA for paging from the paging assistance information or the IE of the second CN-to-BS message and determine to request the DU 174 and/or the other DU(s) to page the UE 102 in accordance with TAI list or RNA. That is, the DU 174 and/or the other DU(s) belong to one or more paging areas identified by the TAI list or RNA. Further, the DU 174 may control more than one cell. In such cases, the DU 174 can page the UE on the multiple cells.

The events 324, 326 and 328 are collectively referred to in FIG. 3A as an enhanced paging procedure 394.

When the UE 102 receives 328 the Paging message via the cell 124, the UE 102 identifies (e.g., validates or verifies) that the NAS ID addresses the UE 102. In response to the identification, the UE 102 can initiate a paging response procedure (e.g., service request procedure) to respond the Paging message. In response to the initiation, the UE 102 performs 330 an RRC connection establishment procedure with the CU 172 via the DU 174 and the cell 124. To perform the RRC connection establishment procedure, the UE 102 can send an RRC request message (e.g., RRCConnectionRequest or RRCSetupRequest message) to the CU 172 via the DU 174. In response, the CU 172 can transmit an RRC response message (e.g., RRCConnectionSetup or RRCSetup message) to the UE 102 via the DU 174. The UE 102 can transmit an RRC complete message (e.g., RRCConnectionSetupComplete or RRCSetupComplete message) to the CU 172 via the DU 174. The UE 102 transitions 372 to a connected state (e.g., RRC_CONNECTED state) in response to the RRC response message. The UE 102 can send a Service Request message to the CN 110 via the DU 174 and CU 172 in response to the Paging message. After the UE 102 transitions to the connected state, the CU 172 can perform 332 a security mode procedure with the UE 102 via the DU 174 to activate security (e.g., integrity protection and/or encryption) for data communication between the UE 102 and CU 172. After activating the security, the CU 172 can perform 334 at least one RRC reconfiguration procedure with the UE 102 via the DU 174 to configure a signaling radio bearer (SRB) and/or a data radio bearer (DRB). Then, the UE 102 communicates (e.g., transmits and/or receives) 336 data with the CN 110 via the CU 172 and the DU 174. The data can include user-plane data packets (e.g., IP packets) and/or control-plane messages (e.g., NAS messages). In some implementations, the UE 102 can communicate 336 the user-plane data packets on the DRB with the CU 172 via the DU 174, where the CU 172 communicates the user-plane data packets with the CN 110. In other implementations, the UE 102 can communicate 336 control-plane messages on the SRB with the CU 172 via the DU 174, where the CU 172 communicates the control-plane messages with the CN 110.

Turning next to FIG. 3B, a scenario 300B is generally similar to the scenario 300A, except that the CN 110 also transmits a paging enhancement configuration to the base station 106 to further expand the reach of an enhanced paging procedure. After the CN 110 performs 392 a NAS paging enhancement enabling procedure with the UE 102 via a CU 172A and a DU 174A of the base station 106, the CN 110 determines to page the UE 102 operating in an idle state. The CN 110 transmits 338 a CN-to-BS message including a paging enhancement configuration to the CU 172A, similar to event 322. The CU 172A then transmits 340 the paging enhancement configuration to the DU 174A in a CU-to-DU message, similar to the event 324. The DU 174A uses the paging enhancement configuration to determine 342 how to page the UE 102, similar to event 326.

In contrast with the successful enhanced paging procedure 394 shown in FIG. 3A, when the DU 174A transmits 343 the paging DCI and/or transmits 344 the Paging message, the paging DCI and/or the Paging message do not reach the UE 102. For example, after transitioning to the idle state, the UE 102 may have moved from the cell 126, served by the base station 106, to the cell 124, served by the base station 104. As a result, the base station 106 does not successfully page the UE 102. However, the CN 110 may transmit a CN-to-BS message including the paging enhancement configuration for the UE 102 to other base stations. For example, the CN 110 may transmit such a CN-to-BS message to the base stations within a paging area of the UE 102, where the paging area may be based on an RNA or a TAI list for the UE 102. Thus, the CN 110 also transmits 322 a CN-to-BS message to a CU 172B of the base station 104 to initiate an enhanced paging procedure 394 at an additional distributed base station. The CU 172B performs 394 the enhanced paging procedure with the UE 102 via a DU 174B of the base station 104 to successfully page the UE 102. In some implementations, instead of receiving 322 the enhanced paging configuration from the CN 110, the CU 172B may receive an enhanced paging configuration from the CU 172A (e.g., via a BS-to-BS message). The CU 172A may determine to transmit the enhanced paging configuration to the CU 172B based on a paging area of the UE 102.

Turning to FIG. 3C, a scenario 300C is initially similar to the scenario 300B. However, the base station 104 includes a CU 172 and two DUs, the DU 174A and the DU 174B. Initially, the CN 110 initiates paging the UE 102 by transmitting 338 a CN-to-BS message including a paging enhancement configuration to the CU 172. The CU 172 attempts to page the UE 102 via the DU 174B, similar to FIG. 3B in which the CU 172A of the base station 106 attempts to page the UE 102 via the DU 174A of the base station 106. The Paging message that the DU 174B transmits 344 does not reach the UE 102. However, via the enhanced paging procedure 394, the CU 172 also sends the paging enhancement configuration in a CU-to-DU message to the DU 174A, and the DU 174A successfully pages the UE 102. The CU 172 may send the paging enhancement configuration to multiple DUS, based on the paging area of the UE 102.

FIGS. 3A-3C illustrate scenarios in which a base station pages a UE when the UE operates in an idle state. In contrast, FIGS. 4A-4D illustrate scenarios in which a base station pages a UE when the UE operates in an inactive state.

Turning first to FIG. 4A, in a scenario 400A the UE 102 initially operates 402 in a connected state (e.g., RRC_CONNECTED) with the base station 104 including a CU 172 and a DU 174. While the UE 102 operates in the connected state, the UE 102 communicates 403 data with the CN 110 via the CU 172 and the DU 174. While communicating 403 with the CN 110, the UE 102 can transmit capabilities and/or assistance information to the CN 110 (e.g., via the CU 172 and the DU 174, similar to events 304, 306, and 308 during the NAS paging enhancement enabling procedure 392). Based on the capabilities and/or assistance information, the CN 110 can generate a paging enhancement configuration. The CN 110 can transmit the paging enhancement configuration to the UE 102 (e.g., via the CU 172 and the DU 174, similar to events 310, 312, and 314 during the NAS paging enhancement enabling procedure 392). Further, after generating the paging enhancement configuration, the CN 110 may transmit 415 a CN-to-BS message including the paging enhancement configuration to the CU 172. In some implementations, the CN-to-BS message can be a Initial Context Setup Request message, a Handover Request message, a Path Switch Request Acknowledge message, or a UE Context Modification Request message.

After a certain period of data inactivity for the UE 102, the CU 172 can determine that neither the CU 172 nor the UE 102 has transmitted any data in the downlink direction or the uplink direction, respectively, during the certain period. In response to the determination, the CU 172 sends 416 a CU-to-DU message including an RRC release message to the DU 174, which in turn transmits 418 the RRC release message to the UE 102. In response to the RRC release message, the UE 102 transitions 421 to an inactive state (e.g., RRC_INACTIVE) and operates in the inactive state.

At a later time, the CN 110 detects DL data for the UE 102. In response, the CN 110 transmits 423 the DL data to the CU 172. In response to receiving 423 the DL data, the CU 172 transmits the paging enhancement configuration to the DU 174 in a CU-to-DU message to cause the DU 174 to page the UE 102. The DU 174 configures 426 paging the UE 102 based on the paging enhancement configuration, similar to event 326. To configure 426 paging the UE 102, the DU 174 determines how to page the UE 102 based on the paging enhancement configuration. The DU 174 then pages the UE 102 in accordance with the determination at event 426. More particularly, the DU 174 transmits 427 a paging DCI to the UE 102 scheduling a Paging message, and transmits 428 the Paging message to the UE 102. For example, based on the determination at event 426, the DU 174 can determine whether to transmit a PEI prior to transmitting 427 the paging DCI and/or whether to indicate a paging subgrouping to the UE 102 when paging the UE 102. The events 424, 426, 427, and 428 are collectively referred to in this disclosure as an enhanced paging procedure 494.

In response to the Paging message, the UE 102 initiates an RRC resume procedure in order to transition to a connected state (e.g., RRC_CONNECTED) and receive the DL data. The UE 102 transmits 446 an RRC resume request message (e.g., RRCResumeRequest message) to the DU 174, which in turn transmits 448 a DU-to-CU message including the RRC resume request message to the CU 172. In response, the CU 172 transmits 450 a CU-to-DU including an RRC resume message (e.g., RRCResume message) to the DU 174, which in turn transmits 452 the RRC resume message to the UE 102. In response to the RRC resume message, the UE 102 transitions 430 to the connected state and operates in the connected state. After transitioning to the connected state, the UE 102 transmits 454 an RRC resume complete message (e.g., RRCResumeComplete message) to the DU 174, which in turn transmits 456 a DU-to-CU message including the RRC resume complete message to the CU 172. The UE 102 can then communicate 458 data with the CN 110 via the CU 172 and the DU 174. In particular, the CU 172 can transmit the DL data to the UE 102. The events 446, 448, 450, 452, 430, 454, 456, and 458 are collectively referred to in this disclosure as a data communication procedure 496.

Turning to FIG. 4B, a scenario 400B is generally similar to the scenario 400A, except that the base station 104 performs early data communication with the UE 102 such that the UE 102 receives the DL data without transitioning to the connected state. The UE 102 transitions 421 to the inactive state, similar to FIG. 4A. After receiving 423 the DL data for the UE 102, the CU 172 pages the UE 102 via the DU 174 using the enhanced paging procedure 494. The CU 172 may include, in the CU-to-DU message that the CU 172 transmits to the DU 174 during the enhanced paging procedure 494, an indication that the UE 102 is to perform early data communication. Accordingly, the DU 174 may include, in the Paging message that the DU 174 transmits to the UE 102, an indication that the UE 102 is to perform early data communication (e.g., the DU 174 may include the indication that the DU 174 receives from the CU 172, or may be an indication that the DU 174 generates).

After receiving the Paging message, the UE 102 transmits 446 an RRC resume request message to the DU 174, which in turn transmits the RRC resume request message to the CU 172 in a DU-to-CU message. The RRC resume request message may include an indication that the UE 102 is initiating early data communication. In contrast to the data communication procedure 496, the CU 172 can then then transmit the DL data to the UE 102 without causing the UE 102 to transition to the connected state. The CU 172 transmits 451 the DL data to the DU 174, which in turn transmits 453 the DL data to the UE 102. In some implementations, after initiating early data communication, the UE 102 can also transmit 455 UL data to the DU 174, which in turn transmits 457 the UL data to the CU 172. The CU 172 can then forward 459 the UL data to the CN 110. After transmitting 451 the DL data (and receiving the UL data, in some implementations), the CU 172 transmits 460 a CU-to-DU message including an RRC release message to the DU 174, which in turn transmits 462 the RRC release message 462 to the UE 102 in order to end the early data communication. The events 446, 448, 451, 453, 455, 457, 459, 460, and 462 are collectively referred to in this disclosure as data communication procedure 497.

Turning next to FIG. 4C, a scenario 400C is generally similar to the scenario 400A or 400B, except that the base station 104 receives the paging enhancement configuration from another base station 106. The UE 102 initially communicates 403 with the CN 110 via the base station 106, and later transitions 421 to the inactive state. The CN 110 then detects DL data for the UE 102 and transmits 439 DL data to the CU 172A of the base station 106, where the base station 106 last served the UE 102 prior to the UE 102 transitioning to the inactive state. The CU 172 then attempts to page the UE 102 via the DU 174A. However, when the DU 174A transmits 443 the paging DCI and/or transmits 444 the Paging message, the paging DCI and/or the Paging message do not reach the UE 102, similar to events 343 and 344 in FIG. 3B. The DU 174A therefore does not successfully page the UE 102.

The CU 172A also transmits 470 the paging enhancement configuration to a CU 172B of a base station 104 in a BS-to-BS message. The CU 172A may determine to transmit 470 the paging enhancement configuration to another base station because the base station 104 is in a paging area of the UE 102 (e.g., based on a TAI list or RNA of the UE 102). The CU 172B can then page the UE 102 via the DU 174B using an enhanced paging procedure 494. After paging the UE 102, the UE 102 receives the DL data from the DU 174B using either the data communication procedure 496 or 497 (i.e., by transitioning to the connected state or by performing early data communication). The CU 172B can receive the DL data from the CU 172A.

Turning to FIG. 4D, a scenario 400D is initially similar to the scenario 400C. However, the base station 104 includes a CU 172 and two DUs, the DU 174A and the DU 174B, similar to the base station 104 in FIG. 3C. Initially, the CN 110 initiates paging the UE 102 by transmitting 421 DL data to the CU 172. The CU 172 attempts to page the UE 102 via the DU 174B, but the Paging message that the DU 174B transmits 444 does not reach the UE 102. However, the CU 172 also sends a paging enhancement configuration in a CU-to-DU message to the DU 174A, and the DU 174A successfully pages the UE 102 via the enhanced paging procedure 494. The CU 172 may send the paging configuration to multiple DUs, based on the paging area of the UE 102.

FIGS. 5-18 are flow diagrams depicting example methods that nodes of a RAN (e.g., the RAN 105) can perform for managing paging a UE (e.g., the UE 102).

FIG. 5 is a flow diagram of a method 500 for determining whether to page a UE using enhanced or legacy paging, which can be implemented by a DU (e.g., the DU 174). At block 502, the DU receives, from a CU (e.g., the CU 172), a CU-to-DU message instructing the DU to page a UE (e.g., the UE 102) (e.g., event 324, 340, 424, 440, or similar events within the procedures 394, 494). In response to the CU-to-DU message, at block 504, the DU generates a Paging message including an identity of the UE (e.g., a NAS ID). The DU also determines, at block 506, whether the DU has a paging enhancement configuration for the UE. The DU may receive the paging enhancement configuration in the CU-to-DU message that the DU receives at block 502 or it may have received a paging enhancement configuration for the UE earlier.

If the DU does have a paging enhancement configuration, then the flow proceeds to block 508. At block 508 the DU uses the paging enhancement configuration to transmit the Paging message to the UE via one or more cells in order to the page the UE (e.g., events 326, 327, 328). For example, based on the paging enhancement configuration indicating UE support for detecting a PEI, the DU may determine to transmit a PEI to the UE prior to transmitting a paging DCI scheduling the Paging message. As another example, the DU may include, in or with the DCI, an indication of a paging subgroup of the UE based on a paging subgroup identified in the paging enhancement configuration, as described above with reference to FIG. 3A.

If the DU does not have a paging enhancement configuration, then the flow proceeds to block 510, where the DU uses a predetermined paging configuration to transmit the Paging message to the UE via one or more cells in order to page the UE. Using the predetermined paging configuration to page the UE corresponds to legacy methods of paging the UE, as described in 3GPP TS 38.304 V16.4.0 Release 16 Section 7.1.

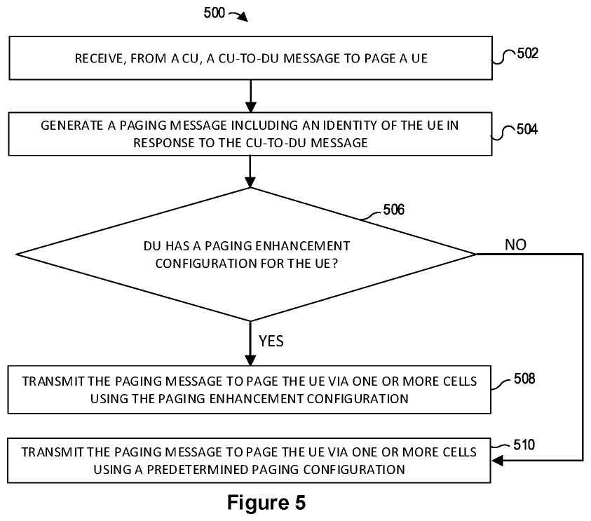

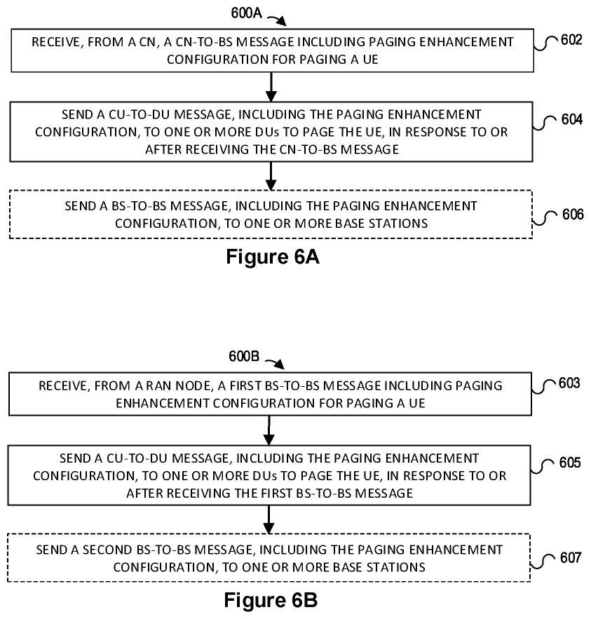

FIGS. 6A-6B are flow diagrams of methods 600A and 600B, respectively, for distributing a configuration for enhanced paging, which can be implemented by a CU (e.g., the CU 172). Beginning with FIG. 6A, at block 602, the CU receives, from a CN (e.g., the CN 110), a CN-to-BS message including a paging enhancement configuration for paging a UE (e.g., the UE 102) (e.g., event 322, 338, 415, 465). In response to or after receiving the CN-to-BS message, at block 604, the CU sends a CU-to-DU message including the paging enhancement configuration to one or more DUs to page the UE (e.g., event 324, 340, 424, 440, or similar events within procedures 394, 494). As discussed previously, the CU may transmit the paging enhancement configuration to multiple DUs within a paging area of the UE. In some implementations, at block 606, the CU sends a BS-to-BS message including the paging enhancement configuration to one or more base stations (e.g., event 470). The CU may send the paging enhancement configuration to multiple base stations within a paging area of the UE.

Referring to FIG. 6B, the method 600B is generally similar to the method 600A. However, at block 603, the CU receives the paging enhancement configuration from a RAN node rather than from the CN, as in block 602. The CU receives, from the RAN node (e.g., a second base station, or a CU or a DU of the second base station), a first BS-to-BS message including a paging enhancement configuration for paging a UE (e.g., event 470). In response to or after receiving the first BS-to-BS message, the CU sends a CU-to-DU message including the paging enhancement configuration to one or more DUs to page the UE, similar to block 604. In some implementations, at block 607, the CU sends a second BS-to-BS message including the paging enhancement configuration to one or more base stations, similar to block 606.

In some implementations, the BS-to-BS message at block 606, 603, or 607 is a RAN paging message for paging the UE. In other implementations, the BS-to-BS message at block 606, 603, or 607 is a Handover Request message. For example, at block 603, the CU (i.e., a target CU) can receive the Handover Request message from the RAN node (e.g., a source CU or a source base station) in a handover preparation procedure for the UE operating in the connected state. In this example, the CU can send a Handover Request Acknowledge message to the RAN node in response to the Handover Request message. In yet other implementations, the BS-to-BS message at block 606, 603, or 607 is a Retrieve UE Context Response message. For example, as a subroutine (not shown) within block 603, the CU (i.e., new CU) transmits a Retrieve UE Context Request message to the RAN node (e.g., an old CU or an old base station) for the UE operating in the inactive state or idle state. In this example, the CU can receive a Retrieve UE Context Response message from the RAN node in response to the Retrieve UE Context Request message.

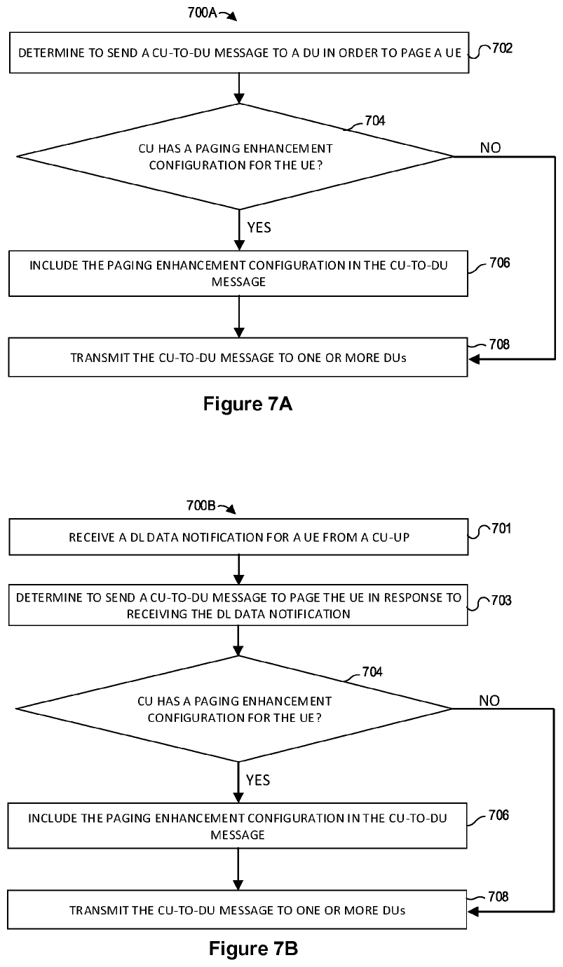

FIGS. 7A-7B are flow diagrams of methods 700A and 700B for transmitting a CU-to-DU message to a DU to instruct the DU to page a UE, which can be implemented by a CU (e.g., the CU 172) and a CU-CP, respectively. Referring first to FIG. 7A, at block 702, the CU determines to send a CU-to-DU message to a DU (e.g., the DU 174) in order to page a UE. At block 704, the CU determines whether the CU has a paging enhancement configuration for the UE. If so, then the flow proceeds to block 706, where the CU includes the paging enhancement configuration in the CU-to-DU message. At block 708, the CU transmits the CU-to-DU message to one or more DUs (e.g., event 324, 340, 424, 440, or similar events within procedures 394, 494). If the CU does not have a paging configuration for the UE, then the flow proceeds directly from block 704 to block 708, and the CU transmits a CU-to-DU message to one or more DUs excluding a paging enhancement configuration.

Referring to FIG. 7B, the method 700B is generally similar to the method 700A. However, the method 700B is performed by a CU-CP. At block 701, the CU-CP receives a DL data notification for a UE from a CU-UP. At block 703, in response to receiving the DL data notification, the CU-CP determines to send a CU-to-DU message to a DU in order to page the UE. At block 704, the CU-CP determines whether the CU has a paging enhancement configuration for the UE. If so, then the CU-CP includes the paging enhancement configuration in the CU-to-DU message before transmitting the CU-to-DU message to one or more DUs at block 708.

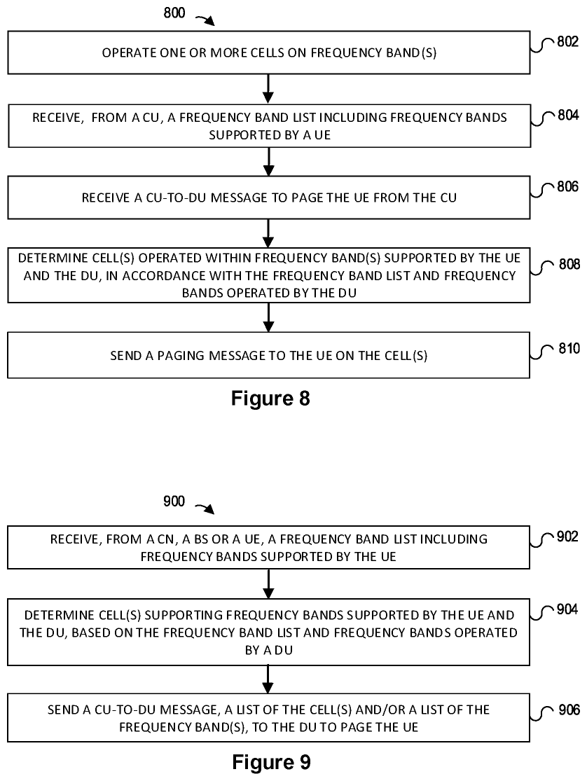

FIGS. 8-11 are flow diagrams of methods 800, 900, 1000, and 1100 for determining a subset of cells on which to page a UE (e.g., the UE 102), which can be implemented by a DU (e.g., the DU 174), a CU (e.g., the CU 172), a base station (e.g., the base station 104 or 106), and a CN (e.g., the CN 110), respectively. After determining the subset of cells using any of the methods 800-1100, a RAN can page the UE on the subset of cells using the enhanced paging mechanisms discussed in this disclosure, or using legacy paging mechanisms (e.g., legacy paging mechanisms as discussed 3GPP TS 38.304 V16.4.0 Release 16 Section 7.1).

Referring first to FIG. 8, a DU at block 802 operates one or more cells, each cell supporting a frequency band. Each cell operated by the DU may support a different frequency band, or some cells of the one or more cells may support the same frequency band. At block 804, the DU receives, from a CU, a frequency band list including frequency bands supported by a UE. As described with respect to FIG. 3, during the NAS paging enhancement enabling procedure 392, one or more frequency band lists may be included in a capability IE from the UE. At block 806, the DU receives a CU-to-DU message from the CU instructing the DU to page the UE. Prior to paging the UE, the DU determines at block 808 the cell(s) operated within frequency band(s) supported by both the UE and the DU, based on the frequency band list and the frequency bands operated by the DU. For example, at block 808, the DU generates a second list of frequency bands including frequency bands of the frequency band list that are also supported by the one or more cells operated by the DU. The second list of frequency bands therefore is an intersection of the frequency band list (i.e., the frequency bands supported by the UE) and the frequency bands supported by the DU. The DU can then determine those cells of the one or more cells operated by the DU that support frequency bands of the second list of frequency bands. At block 810, the DU sends a Paging message to the UE on those cell(s) (i.e., the cells determined at block 808). Thus, the DU pages the UE on the cells that support frequency bands supported by both the DU and the UE.

Referring next to FIG. 9, the method 900 is similar to the method 900, except that a CU, rather than a DU, determines the cells on which the DU should page the UE. At block 902, the CU receives, from a CN, a base station, or a UE, a frequency band list including frequency bands supported by the UE. At block 904, the CU determines (the cell(s) that support) frequency bands supported by both the UE and the DU, based on the frequency band list and the frequency bands operated by the DU. Thus, similar to the DU at block 808, the CU determines a second list of frequency bands including frequency bands of the frequency band list that are also supported by the one or more cells operated by the DU. The CU can then determine those cells of the one or more cells operated by the DU that support frequency bands of the second list of frequency bands. At block 906, to page the UE, the CU sends a CU-to-DU message to the DU including a list of the cell(s) and/or a list of the frequency bands corresponding to those cells (i.e., the second list of frequency bands).

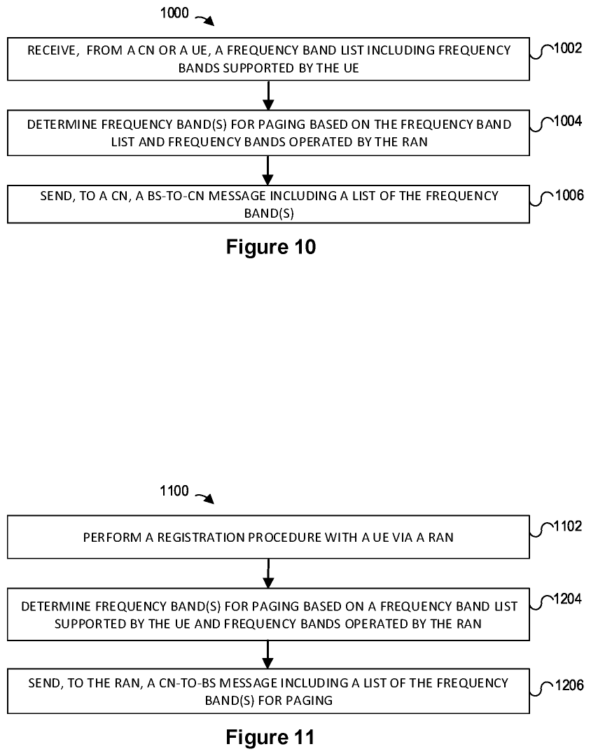

Turning to FIG. 10, the method 1000 is implemented by a CU or a base station. For brevity, the discussion of FIG. 10 refers to a base station as performing the method 1000. At block 1002, the base station receives, from a CN or a UE, a frequency band list including frequency bands supported by the UE. At block 1004, the base station determines frequency band(s) to utilize for paging based on the frequency band list and the frequency bands operated by the RAN. Thus, similar to FIGS. 8-9, the base station determines an intersection of the frequency bands supported by the UE and those supported by the RAN. At block 1006, the base station sends, to a CN, a BS-to-CN message including a list of the frequency band(s) determined at block 1006.

Turning to FIG. 11, the method 1100 is implemented by a CN. At block 1102, the CN performs a registration procedure with a UE via a RAN. At block 1204, the CN determines frequency band(s) to utilize for paging based on a frequency band list indicating frequency bands supported by the UE, and frequency bands operated by the RAN. Thus, the CN determines an intersection of the frequency bands supported by the UE and those supported by the RAN. At block 1206, the CN sends, to the RAN, a CN-to-BS message including a list of the frequency band(s) determined at block 1204, where the RAN utilizes the list of frequency band(s) to page the UE,

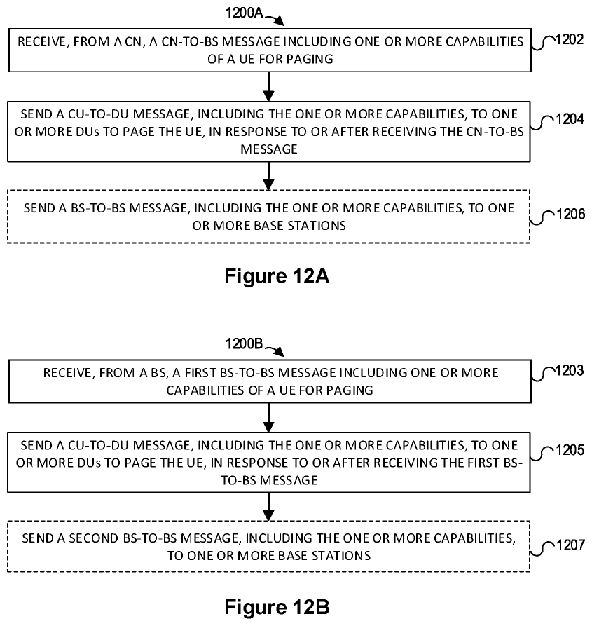

FIGS. 12A-12B are flow diagrams of methods 1200A and 1200B, respectively, for distributing UE paging capabilities, which can be implemented by a CU (e.g., the CU 172). Referring first to FIG. 12A, at block 1202, the CU receives, from a CN, a CN-to-BS message including one or more capabilities of a UE for paging. After or in response to receiving the CN-to-BS message, at block 1204, the CU sends a CU-to-DU message including the one or more capabilities to one or more DUs in order to page the UE. In some implementations, at block 1206, the CU also sends a BS-to-BS message including the one or more capabilities to one or more base stations in order to page the UE. The CU may send the one or more capabilities to the one or more DUs and, in some implementations, the one or more base stations, based on a paging area of the UE.

Turning to FIG. 12B, the method 1200B is generally similar to the method 1200A. However, at block 1203, the CU receives one or more capabilities of a UE for paging from a BS rather than a CN. The CU receives the capabilities in a first BS-to-BS message. In response to or after receiving the first BS-to-BS message, at block 1205, the CU sends a CU-to-DU message including the one or more capabilities to one or more DUs to page the UE. In some implementations, the CU also sends a second BS-to-BS message including one or more capabilities to one or more base stations at block 1207. The CU may send the one or more capabilities to the one or more DUs and, in some implementations, the one or more base stations, based on a paging area of the UE.

In some implementations, the BS-to-BS message at block 1206, 1203, or 1207 is a RAN paging message for paging the UE. In other implementations, the BS-to-BS message at block 1206, 1203, or 1207 is a Handover Request message. For example, at block 1203, the CU (i.e., a target CU) can receive the Handover Request message from the RAN node (e.g., a source CU or a source base station) in a handover preparation procedure for the UE operating in the connected state. In this example, the CU can send a Handover Request Acknowledge message to the RAN node in response to the Handover Request message. In yet other implementations, the BS-to-BS message at block 1206, 1203, or 1207 is a Retrieve UE Context Response message. For example, the CU (i.e., new CU) transmits a Retrieve UE Context Request message to the RAN node (e.g., an old CU or an old base station) for the UE operating in the inactive state or idle state. In this example, the CU can receive a Retrieve UE Context Response message from the RAN node in response to the Retrieve UE Context Request message.

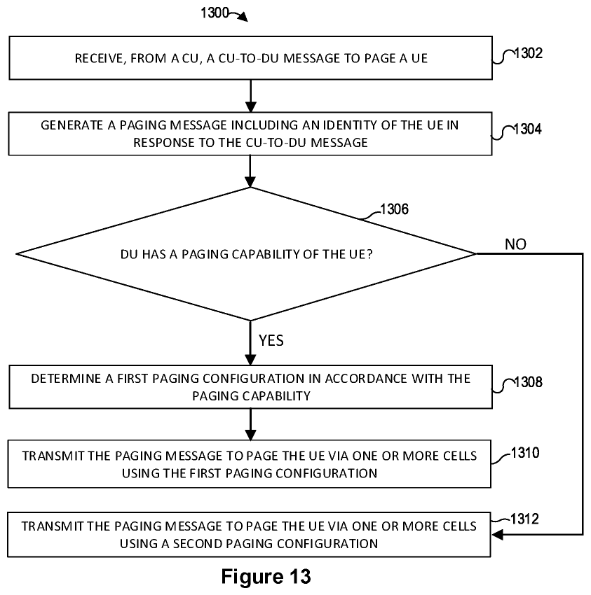

FIG. 13 is a flow diagram of a method 1300 for determining a configuration to use for paging a UE, which can be implemented by a DU (e.g., the DU 174). At block 1302, the DU receives, from a CU, a CU-to-DU message to page a UE. At block 1304, in response to the CU-to-DU message, the DU generates a paging message including an identity of the UE. At block 1306, the DU determines whether the DU has a paging capability of the UE. If so, then the flow proceeds to block 1308. At block 1308, the DU uses the paging capability to determine a first paging configuration for the UE. For example, if the paging capability indicates that the UE supports enhanced paging functions such as detecting a PEI or paging subgrouping, the DU can determine to apply an enhanced paging configuration for the UE. The DU may have previously received the enhanced paging configuration (e.g., from the CU in a CU-to-DU message), or received the enhanced paging configuration in the CU-to-DU message at block 1302.

If the DU does not have a paging capability of the UE, then the flow proceeds from block 1306 to block 1312, where the DU transmits the paging message to page the UE via one or more cells using a second paging configuration. The second paging configuration is a paging configuration that does not include enhanced paging functions, because the DU is not aware of whether the UE supports enhanced paging functions. For example, the second paging configuration can be a predetermined paging configuration, as described in 3GPP TS 38.304 V16.4.0 Release 16 Section 7.1.

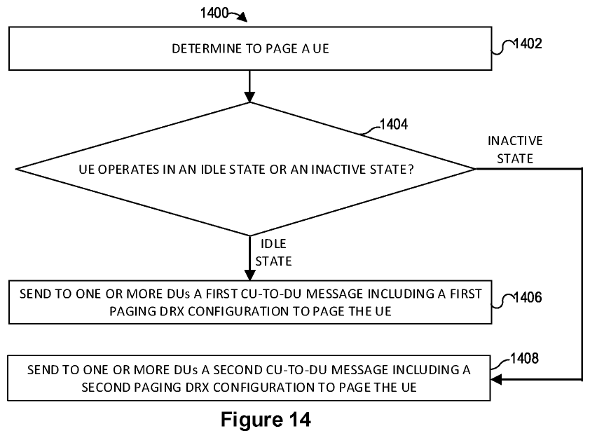

FIG. 14 is a flow diagram of a method 1400 for selecting a paging configuration based on a radio resource control (RRC) state of a UE, which can be implemented by a CU (e.g., the CU 172). At block 1402, the CU determines to page a UE. At block 1404, the CU determines whether the UE is operating in an idle state (e.g., RRC_IDLE) or an inactive state (e.g., RRC_INACTIVE). Based on whether the UE is in the idle or inactive state, the CU selects a paging configuration with which to page the UE. If the UE is in an idle state, at block 1406, the CU sends, to one or more DUs, a first CU-to-DU message including a first paging DRX configuration to page the UE. If the UE is in an inactive state, at block 1408, the CU sends, to one or more DUs, a second CU-to-DU message including a second paging DRX configuration to page the UE.

Each of the first and the second paging DRX configurations may be a paging DRX IE or a Paging eDRX information IE. The first and second paging DRX configurations may be different. For example, the second DRX paging configuration may have a shorter paging (c) DRX cycle or paging time window than the first DRX paging configuration. Further, the first and second paging DRX configurations may originate from different sources. In some implementations, the CU receives the first paging DRX configuration from a CN. In some implementations, the CU determines the second paging DRX configuration by itself.

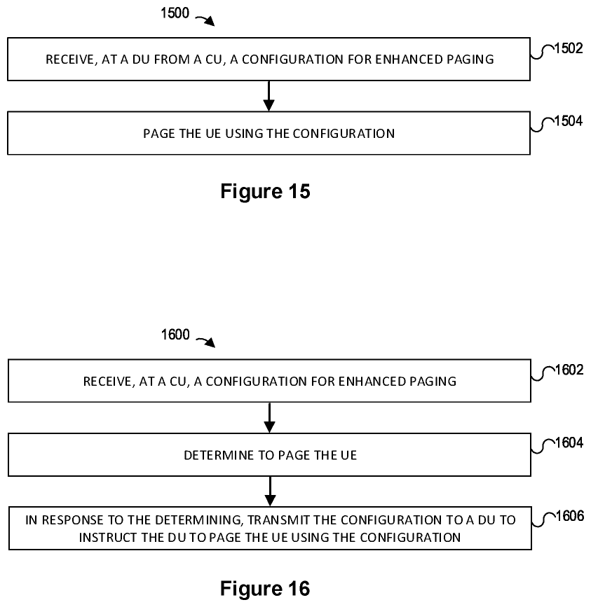

FIG. 15 is a flow diagram of a method 1500 that can be implemented by a DU (e.g., the DU 174) of a distributed base station (e.g., the base station 104 or 106), the distributed base station including the DU and a CU (e.g., the CU 172). The DU can implement the method 1500 to page a UE (e.g., the UE 102) when a radio connection between the distributed base station and the UE is not active (e.g., when the UE operates in an idle or an inactive state).

At block 1502, the DU receives, from the CU, a configuration for enhanced paging (i.e., a paging enhancement configuration) (e.g., events 324, 340, 424, 440). At block 1504, the DU pages the UE using the configuration (e.g., events 326, 327, 328, 426, 427, 428).

In some implementations, based on the configuration, the DU determines that the UE supports detecting a signal that notifies the UE to attempt to receive a paging DCI at a paging occasion (e.g., a PEI signal). In such implementations, paging the UE includes transmitting the signal and, after transmitting the signal, transmitting the paging DCI at the paging occasion. The DU can then transmit a paging message in accordance with the paging DCI. If the DU determines, based on the configuration, that the UE does not support such a signal, then the DU can refrain from transmitting the signal prior to transmitting the paging DCI

In some implementations, based on the configuration, the DU determines that the UE supports paging subgrouping. For example, the DU can determine a paging subgroup of the UE based on the configuration. Paging the UE can then include, based on determining the paging subgroup, transmitting an indication of the paging subgroup to the UE. The DU can transmit the indication by including an identifier of the paging subgroup (e.g., a paging subgroup ID or a subgroup-specific P-RNTI) in a paging DCI, and transmitting the DCI to the UE. Alternatively, the DU can transmit the indication by scrambling a CRC value of the paging DCI using an identifier of the paging subgroup, and transmitting the scrambled CRC value with the paging DCI to the UE. if the DU determines that the UE does not support paging subgrouping or determines that the UE does not belong to a paging subgroup, the DU can transmit a paging DCI omitting an indication of the paging subgroup.

Further, in some implementations, the DU determines, based on the configuration, (i) that the UE supports detecting a signal that notifies the UE to attempt to receive a paging DCI at a paging occasion (e.g., a PEI signal), and (ii) a paging subgroup of the UE. The DU can then page the UE by including an indication of the paging subgroup in the signal, and transmitting the signal to the UE prior to transmitting the paging DCI.

The DU may page the UE when the UE operates in an idle state or an inactive state associated with a protocol for controlling radio resources (e.g., RRC_IDLE or RRC_INACTIVE). When the UE operates in the inactive state, the DU may page the UE by transmitting a paging message including an indication that the UE is to initiate a procedure for receiving data without transitioning to a connected state (e.g., an indication to perform early data communication). Depending on the implementation, the DU may receive the configuration as an IE defined by a protocol conforming to signaling between the CU and the DU (e.g., W1AP or F1AP), or as an IE defined by a protocol for controlling radio resources (e.g., an RRC protocol).

FIG. 16 is a flow diagram of a method 1600 that can be implemented by a CU (e.g., the CU 172) of a distributed base station (e.g., the base station 104 or 106), the distributed base station including the CU and a DU (e.g., the DU 174). The CU can implement the method 1600 to page a UE (e.g., the UE 102) when a radio connection between the distributed base station and the UE is not active (e.g., when the UE operates in an idle or an inactive state).

At block 1602, the CU receives a configuration for enhanced paging (e.g., event 322, 338, 415, 465). At block 1604, the CU determines to page the UE. In response to determining to page the UE, the CU at block 1606 transmits the configuration to the DU to instruct the DU to page the UE using the configuration (e.g., event 324, 340, 424, 440).

In some implementations, the CU receives the configuration as a first IE defined by a protocol to which signaling between a CN and the CU conforms (e.g., NGAP). The CU can decode the configuration from the first IE, encode the configuration as a second IE defined by a protocol to which signaling between the CU and the DU conforms (e.g., F1AP or W1AP), and transmit the configuration to the DU as the second IE. In some implementations, after decoding the configuration, the CU determines that the DU does not support a parameter included in the configuration. The CU can modify the configuration by changing the parameter or excluding the parameter from the configuration, and encode the modified configuration as the second IE.

In some implementations, the CU transmits the configuration to a second node of the RAN, such as a second DU of the distributed base station, or to a second base station. The CU may receive an indication of a paging area (e.g., a tracking area or a RNA) of the UE, and transmit the configuration to the second node based on the paging area. For example, the CU may transmit the configuration to nodes within the paging area of the UE.

The CU may determine to page the UE in response to receiving a message from a CN instructing the CU to page the UE, or in response to receiving data addressed to the UE from a CN, for example. Depending on the implementation, the CU may receive the configuration from a core network, a second base station (or a CU or a DU of a second base station), or the DU.

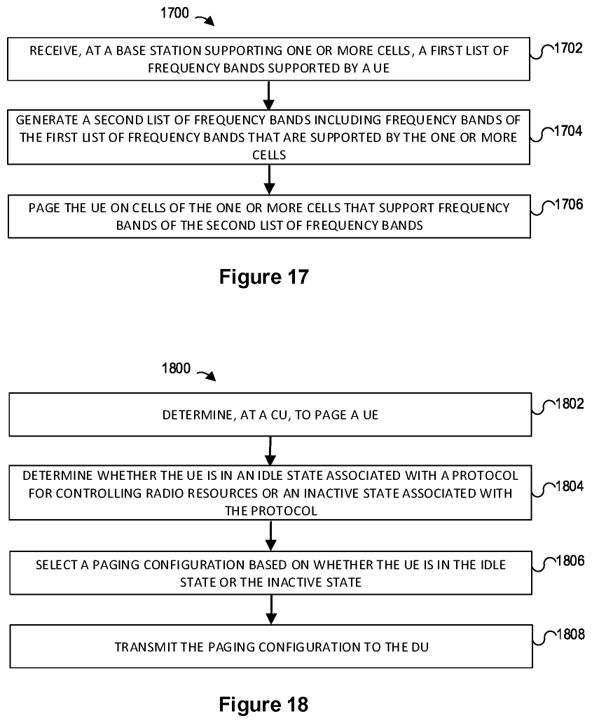

FIG. 17 is a flow diagram of a method 1700 for selecting cells on which to page a UE (e.g., the UE 102), which can be implemented by a base station (e.g., the base station 104 or 106) operating one or more cells. More particularly, the method 1700 can be implemented by a CU (e.g., the CU 172) or a DU (e.g., the DU 174) of the base station. At block 1702, the base station receives a first list of frequency bands supported by the UE. At block 1704, the base station generates a second list of frequency bands including frequency bands of the first list of frequency bands that are supported by the one or more cells. At block 1706, the base station pages the UE on cells of the one or more cells that support frequency bands of the second list of frequency bands. If the method 1700 is implemented by a DU, paging the UE includes sending a paging message on the cells of the one or more cells. If the method 1800 is implemented by a CU, paging the UE may include sending the second list of frequency bands, or a list of the cells of the one or more cells, to a DU of the base station to cause the DU to page the UE on the cells of the one or more cells.

FIG. 18 is a flow diagram of a method 1800 for paging a UE (e.g., the UE 102), which can be implemented by a CU (e.g., the CU 172) of a distributed base station, the distributed base station including the CU and a DU (e.g., the DU 174). At block 1802, the CU determines to page the UE. At block 1804, the CU determines whether the UE is in an idle state associated with a protocol for controlling radio resources or an inactive state associated with the protocol. At block 1806, the CU selects a paging configuration based on whether the UE is in the idle state or the inactive state. At block 1808, the CU transmits the selected paging configuration to the DU.

The following description may be applied to the description above.

In some implementations, “message” is used and can be replaced by “information element (IE)”. In some implementations, “IE” is used and can be replaced by “field”. In some implementations, “configuration” can be replaced by “configurations” or the configuration parameters. In some implementations, “early data communication” can be replaced by “small data communication” and “early data transmission” can be replaced by “small data transmission”.

If a cell is operated in a Time Division Duplex (TDD) mode or on a TDD carrier frequency, a DL BWP and a UL BWP (i.e., associated with the DL BWP) of the cell can be the same BWP. If a cell is operated in a Frequency Division Duplex (FDD) mode or on a pair of FDD carrier frequencies (i.e., UL carrier frequency and DL carrier frequency), a DL BWP and a UL BWP (i.e., associated with the DL BWP) of cell are different BWPs. In this case, the DL BWP is a BWP of the DL carrier frequency and the UL BWP is a BWP of the UL carrier frequency. In some implementations, one of the UL BWPs of a cell can partially overlap the other or has no overlap with the other. In other implementations, one of the UL BWPs can be entirely within the other. In some implementations, one of the DL BWPs of a cell can partially overlap the other or has no overlap with the other. In other implementations, one of the DL BWPs can be entirely within the other.

A user device in which the techniques of this disclosure can be implemented (e.g., the UE 102) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IoT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules may can be software modules (e.g., code, or machine-readable instructions stored on non-transitory machine-readable medium) or hardware modules. A hardware module is a tangible unit capable of performing certain operations and may be configured or arranged in a certain manner. A hardware module can comprise dedicated circuitry or logic that is permanently configured (e.g., as a special-purpose processor, such as a field programmable gate array (FPGA) or an application-specific integrated circuit (ASIC), a digital signal processor (DSP), etc.) to perform certain operations. A hardware module may also comprise programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors.

The following list of examples reflects a variety of the embodiments explicitly contemplated by the present disclosure:

Example 1. A method in a distributed unit (DU) of a distributed base station of a radio access network (RAN), the distributed base station including the DU and a central unit (CU), for paging a user equipment (UE) when a radio connection between the distributed base station and the UE is not active, the method comprising: receiving, by processing hardware of the DU from the CU, a configuration for enhanced paging; and paging, by the processing hardware, the UE using the configuration.

Example 2. The method of example 1, further comprising: determining, by the processing hardware, based on the configuration, that the UE supports detecting a signal that notifies the UE to attempt to receive a paging downlink control information (DCI) at a paging occasion, wherein paging the UE includes: based on the determining, transmitting the signal; and after transmitting the signal, transmitting the paging DCI at the paging occasion.

Example 3. The method of example 1, further comprising: determining, by the processing hardware, based on the configuration, that the UE does not support detecting a signal that notifies the UE to attempt to receive a paging downlink control information (DCI) at a paging occasion, wherein paging the UE includes: based on the determining, refraining from transmitting the signal.

Example 4. The method of any one of examples 1-3, further comprising: determining, by the processing hardware, based on the configuration, a paging subgroup of the UE, wherein paging the UE includes: based on the determining, transmitting an indication of the paging subgroup to the UE.

Example 5. The method of example 4, wherein the DU transmits the indication by: including an identifier of the paging subgroup in a paging downlink control information (DCI); and transmitting the paging DCI to the UE.

Example 6. The method of example 4, wherein the DU transmits the indication by: scrambling a cyclic redundancy check (CRC) value of a paging downlink control information (DCI) using an identifier of the paging subgroup; and transmitting the scrambled CRC value with the paging DCI to the UE.

Example 7. The method of any one of examples 1-3, further comprising: determining, based on the configuration, that the UE does not belong to a paging subgroup, wherein paging the UE includes: based on the determining, generating a paging downlink control information (DCI) omitting an indication of the paging subgroup; and transmitting the paging DCI to the UE.

Example 8. The method of example 1, further comprising: determining, by the processing hardware, based on the configuration, (i) that the UE supports detecting a signal that notifies the UE to attempt to receive a paging downlink control information (DCI) at a paging occasion, and (ii) a paging subgroup of the UE; wherein paging the UE includes: in response to determining, including an indication of the paging subgroup in the signal; transmitting the signal to the UE; and after transmitting the signal, transmitting the paging DCI at the paging occasion.

Example 9. The method of any one of the preceding examples, wherein paging the UE includes: paging the UE when the UE operates in an idle state associated with a protocol for controlling radio resources.

Example 10. The method of any one of examples 1-8, wherein paging the UE includes: paging the UE when the UE operates in an inactive state associated with a protocol for controlling radio resources.

Example 11. The method of example 10, wherein paging the UE includes: transmitting a paging message including an indication that the UE is to initiate a procedure for receiving data without transitioning to a connected state.

Example 12. The method of any one of the preceding examples, wherein the DU receives the configuration as an information element (IE) defined by a protocol conforming to signaling between the CU and the DU.

Example 13. The method of any one of examples 1-11, wherein the DU receives the configuration as an information element (IE) defined by a protocol for controlling radio resources.

Example 14. A method in a central unit (CU) of a distributed base station of a radio access network (RAN), the distributed base station including the CU and a distributed unit (DU), for paging a user equipment (UE) when a radio connection between the distributed base station and the UE is not active, the method comprising: receiving, by processing hardware of the CU, a configuration for enhanced paging; determining, by the processing hardware, to page the UE; and in response to the determining, transmitting, by the processing hardware, the configuration to the DU to instruct the DU to page the UE using the configuration.

Example 15. The method of example 14, wherein: the CU receives the configuration as a first information element (IE) defined by a protocol to which signaling between a core network and the CU conforms; the method further comprises: decoding, by the processing hardware, the configuration from the first IE; and encoding, by the processing hardware, the configuration as a second IE defined by a protocol to which signaling between the CU and the DU conforms; and the CU transmits the configuration to the DU as the second IE.

Example 16. The method of example 15, further comprising: after decoding the configuration, determining, by the processing hardware, that the DU does not support a parameter included in the configuration; and modifying, by the processing hardware, the configuration by changing the parameter or excluding the parameter from the configuration, wherein the CU encodes the modified configuration as the second IE.

Example 17. The method of any one of examples 14-16, further comprising: in response to the determining, transmitting, by the processing hardware, the configuration to a second node of the RAN.

Example 18. The method of example 17, wherein: the DU is a first DU of the distributed base station; and the second node is a second DU of the distributed base station.

Example 19. The method of example 17, wherein: the distributed base station is a first base station; and the second node is a second base station.

Example 20. The method of any one of examples 17-19, further comprising: receiving, by the processing hardware, an indication of a paging area of the UE, wherein transmitting the configuration to the second node includes: transmitting the configuration to the second node based on the paging area.

Example 21. The method of any one of examples 14-20, wherein: the CU receives the configuration for the UE in a message from a core network instructing the CU to page the UE; and the CU determines to page the UE in response to receiving the message.

Example 22. The method of any one of examples 14-20, further comprising: receiving data addressed to the UE from a core network, wherein the CU determines to page the UE in response to receiving the data.

Example 23. The method of any one of examples 14-20, wherein the CU receives the configuration from a core network.

Example 24. The method of any one of examples 14-20, wherein the CU receives the configuration from a second base station.

Example 25. The method of example 24, wherein the CU receives the configuration from a DU of the second base station.

Example 26. The method of any one of examples 14-20, wherein the CU receives the configuration from the DU.

Example 27. A method in a base station for paging a user equipment (UE), the base station operating one or more cells, the method comprising: receiving, by processing hardware of the base station, a first list of frequency bands supported by the UE; generating, by the processing hardware, a second list of frequency bands including frequency bands of the first list of frequency bands that are supported by the one or more cells; and paging, by the processing hardware, the UE on cells of the one or more cells that support frequency bands of the second list of frequency bands.

Example 28. The method of example 27, wherein the method is implemented by a distributed unit (DU) of the base station.

Example 29. The method of example 28, wherein paging the UE includes sending a paging message on the cells of the one or more cells.

Example 30. The method of example 27, wherein the method is implemented by a central unit (CU) of the base station.

Example 31. The method of example 30, wherein paging the UE includes sending the second list of frequency bands to a DU of the base station to cause the DU to page the UE on the cells of the one or more cells.

Example 32. The method of example 30, wherein paging the UE includes: generating a list of the cells of the one or more cells; and sending the list of the cells to a DU of the base station to cause the DU to page the UE on the cells.

Example 33. A method in a central unit (CU) of a distributed base station, the distributed base station including the CU and a distributed unit (DU), for paging a user equipment (UE), the method comprising: determining, by processing hardware of the CU, to page the UE; determining, by the processing hardware, whether the UE is in an idle state associated with a protocol for controlling radio resources or an inactive state associated with the protocol; selecting, by the processing hardware, a paging configuration based on whether the UE is in the idle state or the inactive state; and transmitting, by the processing hardware, the paging configuration to the DU.

Example 34. A node of a radio access network (RAN) comprising processing hardware and configured to implement a method according to any one of the above examples.

What is claimed is:

1. A method in a distributed unit (DU) of a distributed base station of a radio access network (RAN), the distributed base station including the DU and a central unit (CU), for paging a user equipment (UE) when a radio connection between the distributed base station and the UE is not active, the method comprising:
receiving, by processing hardware of the DU from the CU, a paging message indicating whether the UE supports paging subgrouping; and
paging, by the processing hardware, the UE in accordance with whether the UE supports paging subgrouping.

2. The method of claim 1, wherein receiving the paging message includes:
receiving the paging message including a paging subgroup identity of the UE.

3. The method of claim 1 or 2, wherein receiving the paging message includes:
receiving the paging message defined by a protocol conforming to signaling between the CU and the DU.

4. The method of any one of claims 1-3, wherein receiving the paging message includes receiving a UE capability information element (IE) included in the paging message.

5. The method of claim 4, wherein the UE capability IE indicates whether the UE supports paging subgrouping.

6. The method of claim 4 or 5, wherein the UE capability IE indicates whether the UE supports detecting a paging early indication (PEI).

7. The method of any one of claims 1-5, wherein the paging message further indicates whether the UE supports detecting a paging early indication (PEI).

8. A method in a central unit (CU) of a distributed base station of a radio access network (RAN), the distributed base station including the CU and a distributed unit (DU), for paging a user equipment (UE) when a radio connection between the distributed base station and the UE is not active, the method comprising:
determining, by processing hardware of the CU, to page the UE; and
in response to the determining, transmitting, by the processing hardware, the paging message to the DU to instruct the DU to page the UE, the paging message indicating whether the UE supports paging subgrouping.

9. The method of claim 8, wherein transmitting the paging message includes:
transmitting the paging message including a paging subgroup identity of the UE.

10. The method of claim 8 or 9, wherein transmitting the paging message includes:
transmitting the paging message defined by a protocol conforming to signaling between the CU and the DU.

11. The method of any one of claims 8-10, wherein transmitting the paging message includes transmitting a UE capability information element (IE) included in the paging message, the UE capability IE indicating whether the UE supports paging subgrouping.

12. The method of any one of claims 8-11, wherein the paging message further indicates whether the UE supports detecting a paging early indication.

13. The method of any one of claims 8-12, wherein the paging message is a first paging message, the method further comprising:
in response to the determining, transmitting, by the processing hardware, a second paging message to a second node of the RAN, the second paging message indicating whether the UE supports paging subgrouping.

14. The method of any one of claims 8-13, further comprising:
receiving, by the processing hardware prior to determining to page the UE, a message from a core network instructing the CU to page the UE, the message indicating whether the UE supports paging subgrouping; wherein
the CU determines to page the UE in response to receiving the message.

15. A node of a radio access network (RAN) comprising processing hardware and configured to implement a method according to any one of the above claims.
